(19) United States
(12) Patent Application Publication
(10) Pub. No.: US 2024/0181637 A1
(43) Pub. Date: Jun. 6, 2024

(54) AUTONOMOUS HUMANOID ROBOT

(71) Applicant: Carla R. Gillett, Sacramento, CA (US)

(72) Inventor: Carla R. Gillett, Sacramento, CA (US)

(73) Assignee: Carla R. Gillett, Sacramento, CA (US)

(21) Appl. No.: 17/870,793

(22) Filed: Jul. 21, 2022

(51) Int. Cl. B25J 9/16; B25J 17/00; B62D 57/028

(52) U.S. Cl. CPC B25J 9/1664; B25J 9/162; B25J 9/1697; B25J 17/00; B62D 57/028

(57) ABSTRACT

An autonomous humanoid robot configured to overcome limited maneuvering issues by offering a more efficient autonomous humanoid robot that autonomously operates to interact with users and interact with other robots, and includes a computing system configured to provide instruction and programming for estimating and controlling pivotal movement of body components involving arms, legs and a waist module which are configured to support the body and reposition the body such that the autonomous humanoid robot can step, walk, roll or skate or perform various handling maneuvers to complete tasks.

### CROSS REFERENCED TO RELATED APPLICATIONS

A notice of issuance for a continuation in part in reference to patent application Ser. No. 16/852,470 filing date: Apr. 18, 2020, titled: “Humanoid Robot For Accomplishing Maneuvers Like Humans”.

### FIELD

The present disclosure relates to autonomous humanoid robots having artificial intelligence controlling joint angle processes for repositioning pose maneuvers in operating environments involving; walking, running, skating, dancing, and for controlling interchangeable autonomy devices to manipulate still or moving object during job assignments.

### BACKGROUND

As the demand to employ highly intelligent autonomous humanoid robots capable of acrobatic motion to manage most job requirements for example, todays mobile autonomous humanoid robots realize dynamic motion states and balance when navigating or the motion state of the autonomous humanoid robot however the motion and balance of a humanoid when navigating or repositioning poses during operation may harm an autonomous humanoid robot.

However, at present, functional safety surrounding autonomous humanoid robot beings has not been achieved, and a rule is set such that an autonomous humanoid robot being close to the autonomous humanoid robot can be dangerous.

In order to achieve functional safety not only for autonomous humanoid robots but also for pets and other animals, it is necessary to give value order to autonomous humanoid robots for insuring rules of safety exampled by the three principles of autonomous humanoid robot engineering devised by scientific novelist Asimov known as; Article 1 Autonomous humanoid robots must not harm autonomous humanoid robots. Also, do not harm autonomous humanoid robots by overlooking the danger. Article 2 Autonomous humanoid robots must obey the commands given to autonomous humanoid robots. Provided, however, that this shall not apply if the order given is contrary to Article 1. Article 3 Autonomous humanoid robots must protect themselves as long as there is no fear of violating Article 1 and Article 2 above. Source: “I am a robot” by Isaac Asimov.

Since autonomous humanoid robots are mechanically and electrically complicated, reliability problems like sluggish movement, leaning or falling will arise which can harm autonomous humanoid robots, animals or property, what is needed is reliable updated autonomous distributed control to detect abnormal situations affecting the functional motions and to safely charge the batteries a humanoid autonomous humanoid robots when powered off.

What is necessary for the advancement of autonomous humanoid robot artificial intelligence (AI) technology is developing improved tactile mobility and integrated handling skills to complete complex tasks 1060 or to entertain users, the present autonomous humanoid robot provides processor implemented methods and steps for controlling a humanoid autonomous humanoid robot's motion state and entertainment performance, and applications directed at physical maneuvering.

Presently most autonomous humanoid robots feature trajectory by a position sensor based on the motion state of the autonomous humanoid robot however the motion and balance of a humanoid when navigating or repositioning is sluggish and when the autonomous humanoid robot falls an improved fall recovery process is needed.

As the demand to employ highly intelligent autonomous humanoid robots to manage most job requirements what is needed are autonomous humanoid robots providing improved tactile mobility and integrated handling skills to complete complex tasks or to entertain users, the present autonomous humanoid robot provides processor implemented methods and steps for controlling a humanoid autonomous humanoid robot's motion state and entertainment performance.

Autonomous humanoid robotic technology is under development in many academic and industrial environments.

With the continuous improvement of living standards and advances in technology, it is desirable for more activities to be automated or conducted by a humanoid robotic system in particular, to perform autonomous humanoid robot activities in various situations on the living environment of everyday life while taught by autonomous humanoid robot learning adaptation to interface the movements between autonomous humanoid robots and people.

Currently, designing a humanoid robot to perform a plurality of tasks of varying complexity autonomously may be difficult if not impossible based on a current service robot design in which current standards produce sluggish joint mechanisms to move the legs and feet to achieve stepping or walking.

### SUMMARY

In order to solve the abovementioned problems, the present humanoid robot overcomes limited maneuvering issues by offering a more efficient autonomous humanoid robot configured to overcome limited maneuvering issues by offering a more efficient humanoid robot that autonomously operates to interact with users and interact with other robots. In various elements the body components of the humanoid robot comprise arms, legs and a waist module which are configured for supporting and balancing the body which is achieved by a computing system configured to provide instruction and programming for estimating and controlling pivotal movement to counter balance the body and reposition the body components such that the autonomous humanoid robot can step, walk, roll or skate and perform various handling maneuvers to complete tasks.

The computing system, based on an application establishes a switching sequence to initiate an operating mode function involving; a step mode, a walking mode, a roll/skate mode, a leap/jump mode, a battery charging mode which causes a sleep state.

Accordingly by combinations thereof, the autonomous humanoid robot can perform various physical motion states involving at least one of the following acts; a sports activity, a series of dance movements, perform a vehicle-like mobility service, or when operating as a mule or a towing-vehicle, accordingly the autonomous humanoid robot can transport a payload or an object.

In various elements, the autonomous humanoid robot comprises a plurality of perception sensors and cameras configured for detecting object surrounding the autonomous humanoid robot, the sensors and cameras providing sensor data and image data to a computing system comprising a plurality of processors.

In various elements, the autonomous humanoid robot comprises a computer-implemented, based on a battery storage level, a processor to activates a charging module to charge one or more batteries so that power is controlled, by the computing system, to engage and regulate velocity of the joints and motors of the body.

In various elements, the autonomous humanoid robot comprises a computer-implemented control method configured for collecting posture information of posture sensors disposed on the body for estimating motion and position of the autonomous humanoid robot.

In various elements, the autonomous humanoid robot comprises a balance control algorithm, and a momentum planning algorithm configured for estimating joint angular velocities of all joints of the autonomous humanoid robot according to a pose return-to-zero algorithm.

In various elements, the autonomous humanoid robot comprises instructions for accomplishing pose control on the autonomous humanoid robot according to a first set of joint angular velocities, the second set of joint angular velocities, and the third set of joint angular velocities.

In various elements, wherein the arm rotatably coupled a shoulder independently pivoting the arm with at least two degrees of freedom relative to the main body to accomplish reaching movement of the arm; wherein the shoulder joint and the pivotal elbow joint are simultaneously yet independently drivable by the motor to create forward and reverse motions relative to counter-balancing bending motions of the body.

In various elements, wherein the hip joint of the leg rotatably coupled to a hip portion of the body, the hip joint for pivoting the leg with at least two degrees of freedom relative to the main body to accomplish swiveling movement of the leg; and wherein the joints about which the leg may move relative to the main body with at least two degrees of freedom of movement; and wherein the hip joint and the pivotal knee joint are simultaneously yet independently drivable by the motor to create forward and reverse stepping motions, or walking motions, jumping motions, or other humanlike maneuvers.

In various elements, wherein the drive assembly further comprises a joints and joint sensors for imparting driving pivotal movement to the hip joint, pivotal movement the knee joint, and rolling motion to the wheeled foot, respectively.

In various elements, the autonomous humanoid robot comprises a drive system for accomplishing the motor to drive the pivoting movement of the knee joint and the rolling motion of the wheeled foot.

In various elements, wherein the waist module further securable relative to the main body, the waist module having a joint assembly adapted to pivot with at least two degrees of freedom relative to bending or twisting at a center portion of the body.

In various elements, the autonomous humanoid robot comprises a swivel assembly secured to a hip portion of the body, the swivel assembly adapted to cooperate with the swivel shafts to pivot the leg with at least two degrees of freedom relative to the body.

In various elements, wherein the leg comprises a wheeled foot having a motor, when immobile (e. g., powered OFF), the wheeled foot may be propelled upwards to step, or when mobile (e. g., powered ON), the motor propels at a slow speed to roll forward or backward, or the motor propels at a fast speed to skate.

In various elements, wherein processors are configured for activating a charging module to charge one or more batteries so that power is controlled to regulate velocity of the joints and motors of the body.

In various elements, wherein the computer-implemented control method comprising: collecting posture information of posture sensors disposed on the body for estimating a first set of joint angular velocities of all joints of the autonomous humanoid robot according to a balance control algorithm; instructions for estimating a second set of joint angular velocities of all joints of the autonomous humanoid robot according to a momentum planning algorithm such that the autonomous humanoid robot can step, walk, roll, or skate.

In various elements, the instructions are configured for estimating a third set of joint angular velocities of all joints of the autonomous humanoid robot according to a pose return-to-zero algorithm; and instructions for accomplishing pose control on the autonomous humanoid robot according to the first set of joint angular velocities, the second set of joint angular velocities, and the third set of joint angular velocities.

### BRIEF DESCRIPTION OF THE DRAWINGS

FIG. 1 is a front view of the autonomous humanoid robot 100 accomplishing a series of sport or gameplay maneuvers for bending to obtain an object 116 according to an exemplary embodiment of this disclosure.

FIG. 1A is a front view of the autonomous humanoid robot 100A according to an exemplary embodiment of this disclosure.

FIG. 1AA is a rear view of the autonomous humanoid robot 100A according to an exemplary embodiment of this disclosure.

FIG. 2 is a flow chart of a coordinate vector respective of the joint actuator space of the operating environment 1600 according to an exemplary embodiment of this disclosure.

FIG. 2A-2B illustrate flow charts of the processor processes for estimating a first set of joint angular velocities of all joints of the autonomous humanoid robot according to an exemplary embodiment of this disclosure.

FIG. 3 is a flow chart of a process of sub steps for calibrating joint velocity, motion and position of the arms and legs of the autonomous humanoid robot according to an exemplary embodiment of this disclosure.

FIG. 4 illustrates perspective views the head, the arms and the leg components of the humanoid robot according to an exemplary embodiment of this disclosure.

FIG. 5 and FIG. 5A illustrate perspective views of a waist and hip and center mass Y, Y, Z axis elements according to an exemplary embodiment of this disclosure.

FIGS. 6A-6D illustrate the autonomous humanoid robot 100 accomplishing a series of maneuvers in various settings of an operating environment 1600.

FIGS. 7A-7B flow chart of processor process respective of FIG. 2 for controlling motion and position of the arms and legs of the autonomous humanoid robot according to an exemplary embodiment of this disclosure.

FIGS. 8A-8G illustrate perspective views of the autonomous humanoid robot according to an exemplary embodiment of this disclosure.

FIGS. 9A-9D illustrate perspective views of the autonomous humanoid robot according to an exemplary embodiment of this disclosure.

FIG. 10 is a diagram of a computing system 1000 of the autonomous humanoid robot according to an exemplary embodiment of this disclosure.

FIG. 11 illustrate a flowchart of a user interface system 1100 of the autonomous humanoid robot 100 according to an exemplary embodiment of this disclosure.

FIG. 12 is a diagram of a face recognition system 1200 of the autonomous humanoid robot according to an exemplary embodiment of this disclosure.

FIG. 13 is a diagram of a voice recognition system 1300 of the autonomous humanoid robot according to an exemplary embodiment of this disclosure.

FIG. 14 is a diagram of an autonomous humanoid robot interface 1400 of the autonomous humanoid robot according to an exemplary embodiment of this disclosure.

FIGS. 15A-FIG. 15C illustrate side and front views of autonomous humanoid robot 100 and a smart docking station 1500 configured with a battery charging process according to an exemplary embodiment of this disclosure.

FIG. 16 is a diagram of an operating environment 1600 of the autonomous humanoid robot according to an exemplary embodiment of this disclosure.

### DETAILED DESCRIPTION OF THE DRAWINGS

The present autonomous humanoid robot comprises artificial intelligence using neural networks and other computer hardware and software devices and methods to simulate human intelligence for an autonomous humanoid robot 100, according to embodiments of the present technology, to overcome limited maneuvering issues by offering a more efficient autonomous humanoid robot that autonomously operates to interact with users and interact with other robots and operates to move by stepping walking or rolling on various surfaces to get to a destination.

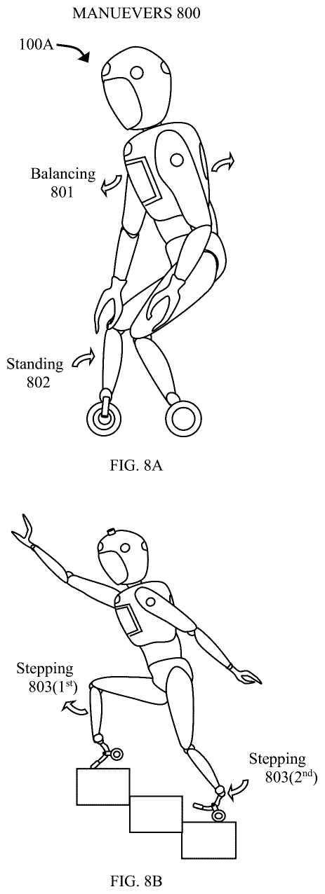

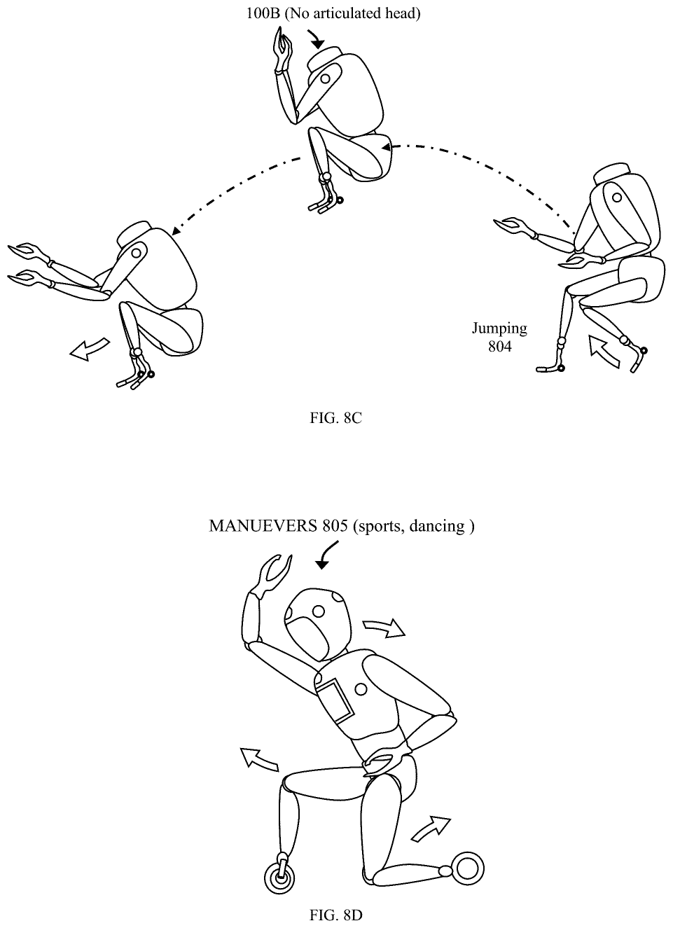

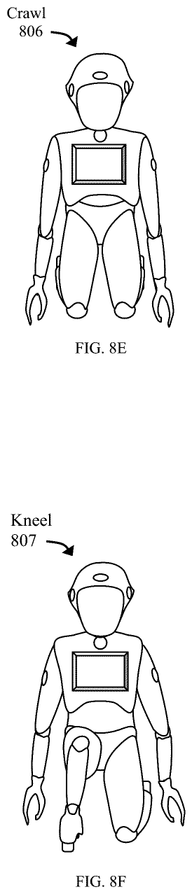

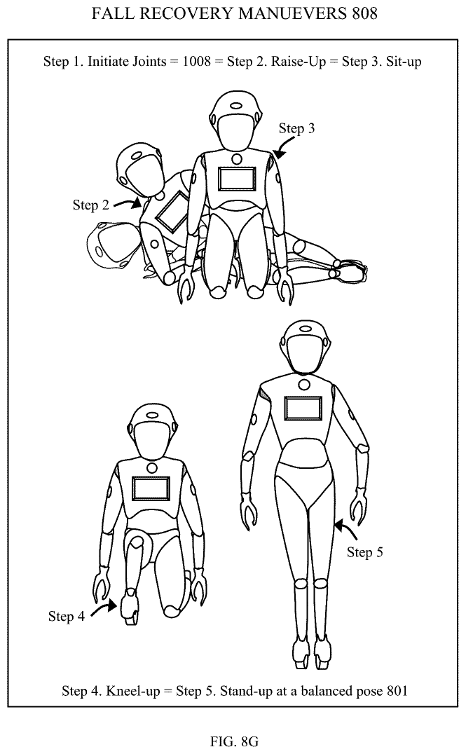

The autonomous humanoid robot's body is configured as a biped or two legged humanoid robot, which may encounter a tall step that it is ordinarily incapable of scaling using a standard walking behavior. The steady-state walking behavior may involve lifting the legs from underneath the body and placing them in a forward position to move the body forward. However, when coming across a tall step, a coordinated motion may be utilized in order to ascend the step. The autonomous humanoid robot's body utilizes a two legs, by operating the legs bend into position, then exerting a large force against the ground the wheeled foot may be propelled upwards to take a tall step onto stairs, or cause steady-state walking behavior, or achieve a “hopping” motion that propels the autonomous humanoid robot's wheeled feet 108L-108R to the height that propels the autonomous humanoid robot's body to leap or jump upwards, as exampled in FIG. 8C.

In various, a computer-implemented control method calibrates, and controls motion and velocity of various maneuvers exampled herein. The maneuver's include but are not limited to; balancing 801, standing 802, stepping 1^{st} and walking 803 2^{nd}, jumping 804, acrobatics 805 to play sports or perform dance moves and perform other entertainment, crawling 806, kneeling 807, and fall recovery calibrated a series of aforementioned maneuvers causes the autonomous humanoid robot to become upright.

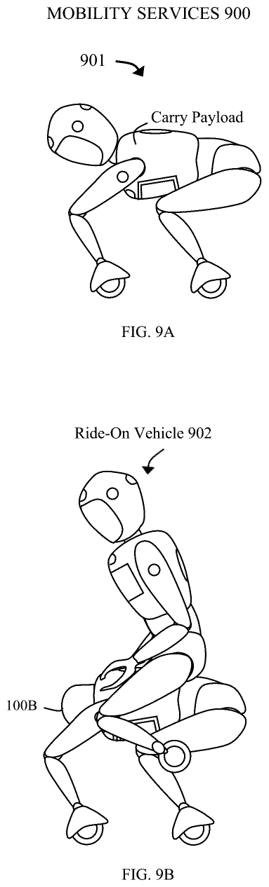

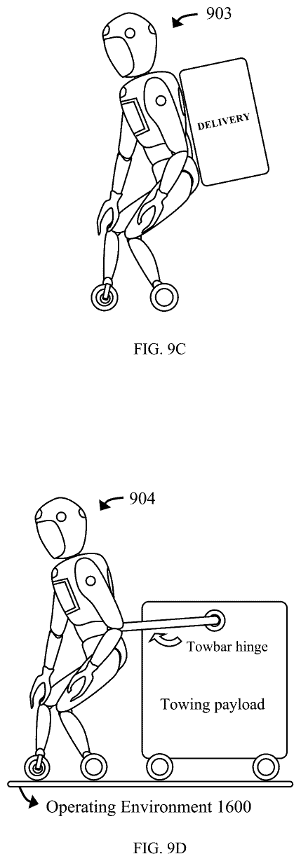

The computing system, based on an application establishes a switching sequence to initiate a series of operating mode functions 1050 which allows the autonomous humanoid robot to perform various physical motion states, such that the autonomous humanoid robot can transport a payload or an object 116, and achieve one or more of the following acts to perform a vehicle-like mobility service to carry a payload 901, exampled in FIG. 9A; a ride-on vehicle 902, exampled in FIG. 9B; to perform a delivery service 903, exampled in FIG. 9C; and to perform a mule or a towing-vehicle 904, exampled in FIG. 9D.

The autonomous humanoid robot 100 comprising user instruction 1101(I) achieved by a user interface system 1100 which the user 1101 of the autonomous humanoid robot can also utilize face recognition 1200, voice recognition 1300 respective of autonomous humanoid robot interface 1400 linking the autonomous humanoid robot to communicate with the user via the control panel 114 or via a wireless communication device which allows the autonomous humanoid robot to interact with the user 1101 by speaking or by reacting through physical motion responses.

The user interface associated with a humanoid robot interface linking the autonomous humanoid robot to communicate with the user via the control panel or via a wireless communication device which allows the autonomous humanoid robot to interact with the user by speaking or by reacting through physical motion responses.

A computer readable medium operational related to the autonomous humanoid robot, the computer readable medium is encoded with instructions which when executed by the computing system perform the steps for positioning the autonomous humanoid robot, which is to self-propel to a first designated geographical location, within a geographical boundary of an operating environment.

The computing system configured to provide instruction and programming for estimating and controlling pivotal movement of body components involving arms, legs and a waist module which are configured to support the body and reposition the body such that the autonomous humanoid robot can step, walk, roll or skate or perform various handling maneuvers to complete task 1060.

The autonomous humanoid robot includes a computing system configured to provide instruction and programming for estimating and controlling pivotal movement of a body configuration having arms, legs and a waist module configured for supporting and balancing the autonomous humanoid robot. In various elements the autonomous humanoid robot comprises a computing system configured to provide instruction and programming for estimating pivotal movement of the autonomous humanoid robot achieved by the drive assembly configured for initiating attitude of one or more joint mechanisms to mutually cross, swing, expand or retract at multiple joint angles, such that the arms, the legs and the waist module provide repositioning movement to bend.

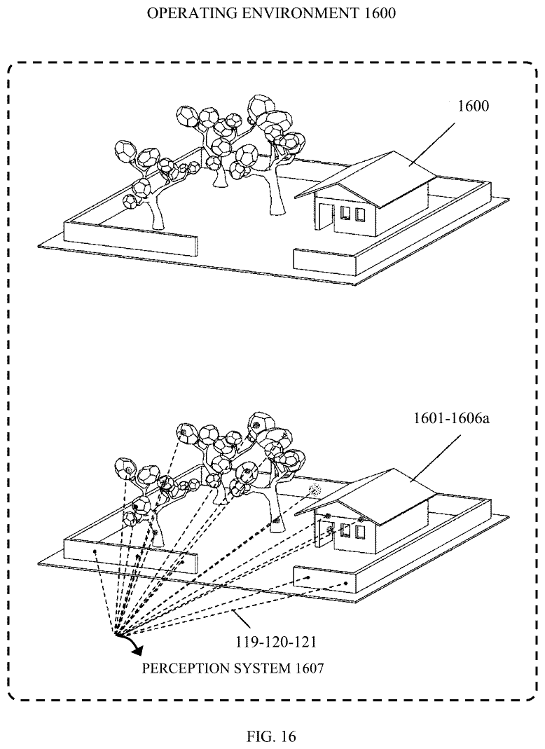

In various aspects the computing system 1000 associated with a computer readable medium operational related to the autonomous humanoid robot, the computer readable medium is encoded with instructions which when executed by the computing system 1000 perform the steps of: positioning the autonomous humanoid robot, which self-propel to a first designated geographical location, within a geographical boundary, as detailed in FIG. 16.

In various aspects the computing system 1000 utilizes one or more processors 1001 to control autonomous navigation operations to travel about automatically changing from one operating mode function 1050 to another operating mode function 1050, respectively to maneuver according to the operating environment 1600.

In various elements, a computer-implemented control method controls motion and velocity of the wheeled foot's motor, when static, the wheeled foot is configured to achieve a stepping motion or a walking motion which is achieved by a computer-implemented dynamic footprint set generation method obtaining preset footprint calculation parameters, such that the autonomous humanoid robot can achieve a stepping motion or a walking motion to navigate up and down stairs or maneuver through obstructions.

In various elements, a computer-implemented control method comprising: collecting posture information of posture sensors disposed on the body for estimating a first set of joint angular velocities of all joints of the autonomous humanoid robot according to a balance control algorithm.

Wherein, the present autonomous humanoid robot 100 is configured with a plurality of motion sensors like the IMU 123, gyros 124, and accelerometers 125 are configured to localize motion trajectory and provide dynamic data of roll, pitch, yaw of one or more joint mechanisms, servos, actuators, the motion trajectory providing X, Y and Z axis mutually crossing at multiple joint angles and counteracting angles, which are exampled as various curved arrows.

In various elements, a computer-implemented instructions for estimating a second set of joint angular velocities of all joints 104/106 of the autonomous humanoid robot according to a momentum planning algorithm; instructions for estimating a third set of joint angular velocities of all joints 104/106 of the autonomous humanoid robot according to a pose return-to-zero algorithm; and instructions for accomplishing pose control on the autonomous humanoid robot according to the first set of joint angular velocities, the second set of joint angular velocities, and the third set of joint angular velocities such that the autonomous humanoid robot can step, walk, roll, skate, or perform acrobatic maneuvers to complete various tasks 1060 based on user instruction 1101(I).

In various elements, the computing system 100, based on an application 1004 establishes a switching sequence to initiate an operating mode function 1050 involving; a step mode 1051, a walking mode 1052, a roll or skating mode 1053, a leap mode or jumping mode 1054, a battery charging mode 1055 and a fall recovery mode 1056, accordingly by combinations thereof, the autonomous humanoid robot can perform various physical motion states involving at least one of the following acts; a sports activity, a series of dance movements, perform a vehicle-like mobility service, or when operating as a mule or a towing-vehicle, accordingly the autonomous humanoid robot can transport a payload or an object 116, as detailed herein.

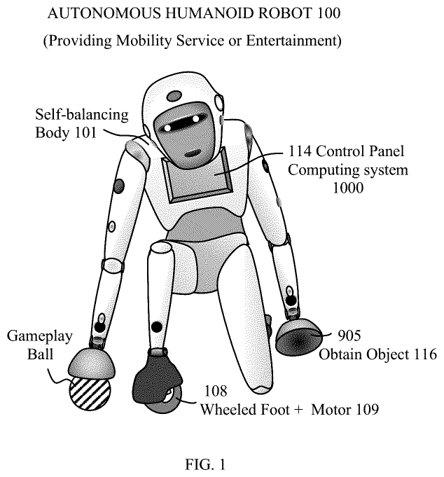

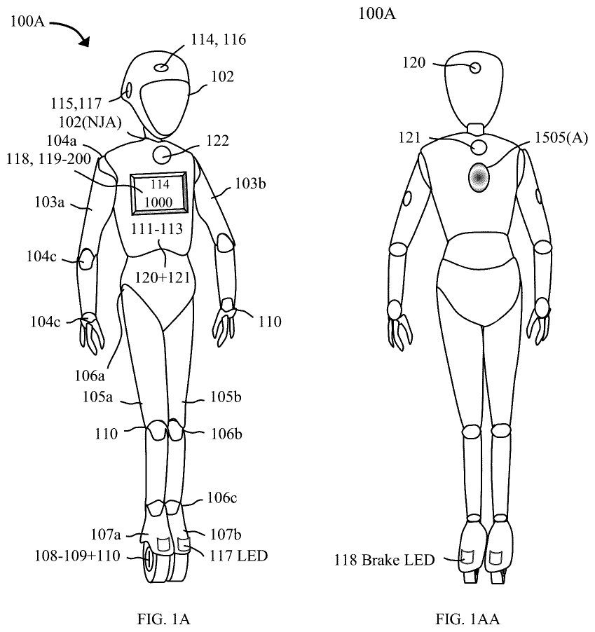

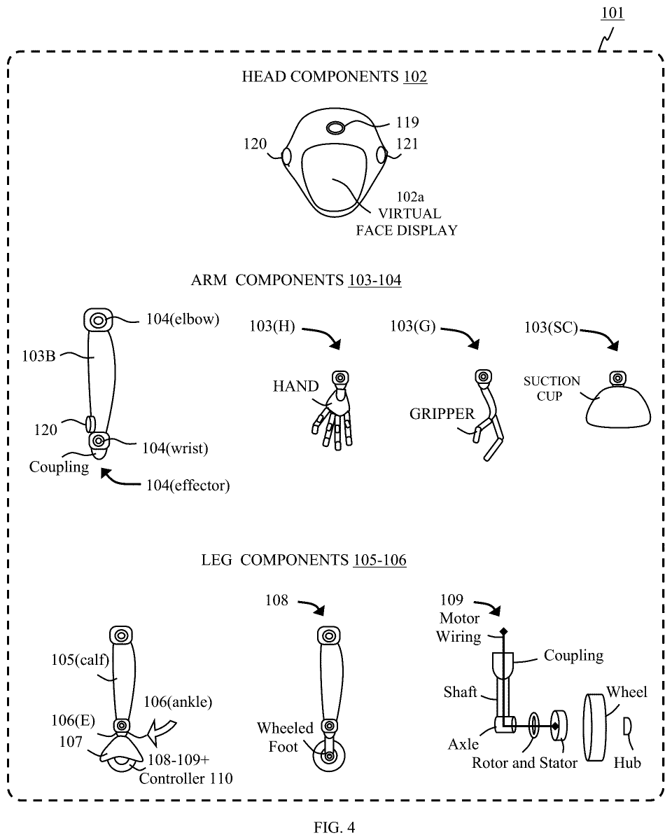

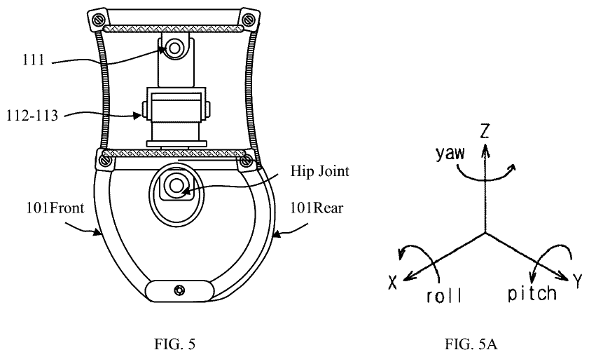

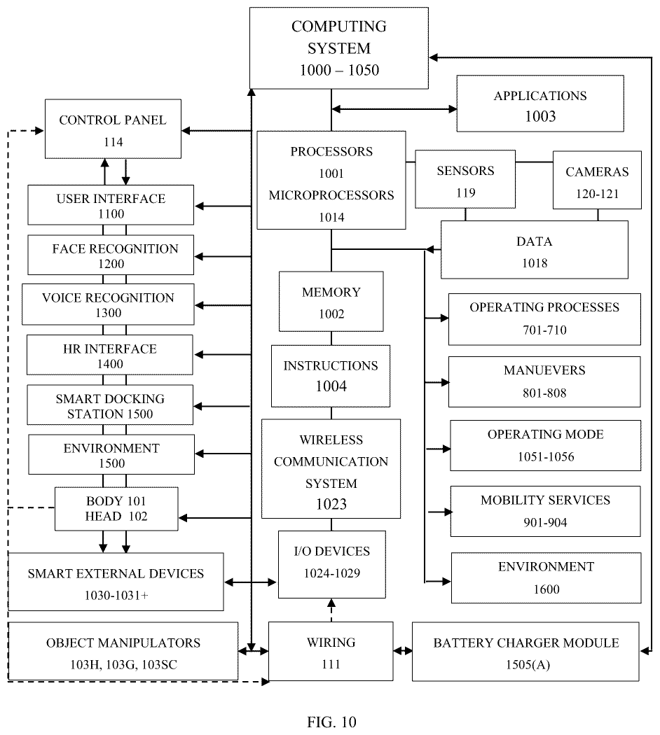

In greater detail FIG. 1 examples the autonomous humanoid robot 100 accomplishing a series of maneuvers for bending forward and reaching, as exampled, a maneuver to pick up a ball 116(B). Accordingly, the autonomous humanoid robot having a body 101 comprising a head 102 attached to a torso module 500 comprising one or more joint servos 501, exampled in FIG. 5A. Respectively, the body having a plurality of proximity sensors 119, LIDAR, RADAR and cameras 120, 121, or other sensors linking to a computing system 1000, accordingly the body 101 comprising arms 103a, 103b and legs 105a, 105b having movable portions configured for an adjustment operation to adjust at least one of a position and a direction of manipulators 103(H), 103(G), 103(SC) exampled in FIG. 4. Respectively the autonomous humanoid leg 105 is attached to the wheeled foot 108 is configured for providing mobility in an operating environment 1600. Respectively the is configured to change various physical actions such that the autonomous humanoid robot 100 can physically move similar to how a human physically moves, in various physical elements the present autonomous humanoid robot is configured with a more efficient body 101, in which the computing system 1000 exampled in FIG. 10, controls a task 1060 like handling objects 1010 and provides object handling instruction 1016 for maneuvering a manipulator to pick up an object 116 or complete other task functions 1060.

The body includes a drive assembly comprising a motor or servo controller 110 configured to initiate electric power which operatively activates joints of the arms, legs and a waist module. Accordingly, each arm includes a respective shoulder joint, an elbow joint, a wrist joint, and an implement; and the wrist joint for independently driving pivotable movement for reaching to obtain an object 116; and accordingly each leg includes a respective pivotal hip joint, a pivotal knee joint, and a wheeled foot adapted to step, walk or roll along a surface.

The wheeled foot's motor, when immobile (e. g., powered OFF), causes the wheeled foot to propel upwards to step, or the wheeled foot's motor, when mobile (e. g., powered ON), causes the wheeled foot's motor to propel at a slow speed to roll forward or backward, or the wheeled foot's motor propels at a fast speed to skate.

The drive assembly comprising a motor operatively associated with the hip and knee joints and the wheeled foot for independently driving pivotal movement of the hip joint and the knee joint and rolling motion of the wheeled foot and the waist module operatively associated with a joint providing yaw, roll, and pitch motion for counter balancing the body at center mass (CM).

In various elements, a drive assembly of one or more joint mechanisms causes the arms and legs to mutually cross, swing, expand or retract at multiple joint angles, such that the arms or the legs achieve various maneuvers to complete work service tasks 1060 like handle objects, and to step, walk, roll, skate to travel.

A plurality of perception sensors and cameras configured for detecting object 116 surrounding the autonomous humanoid robot, the sensors and cameras providing object data and image data to a computing system comprising a plurality of processors.

A processor to activates a charging module 1505(A), based on a battery storage level, configured to charge one or more batteries 113 so that power is controlled, by the computing system 1000, to engage and regulate velocity of the joints and motors of the body 101.

A computer-implemented control method configured for collecting posture information of posture sensors disposed on the body configured for estimating motion and position of the autonomous humanoid robot.

The computing system is configured to provide instruction and programming for estimating pivotal movement of the arms, legs and waist module, the pivotal movement configured for supporting and balancing the autonomous humanoid robot.

The computing system is configured to provide instruction and programming for controlling a steering function achieved by joint mechanisms of the hips to mutually turn at various angles, the steering function allows the autonomous humanoid robot to steer at left and right forward or reverse directions or to spin around during an operating mode function 1050.

In various elements, a computer-implemented control method calibrates and controls motion and velocity of legs to achieve traverse repositioning of the wheeled foot 108, such that the wheeled foot drives the autonomous humanoid robot through a predetermined path, when, the wheeled foot's motor 109 is controlled by a controller 110, the controller is configured to initiate electric power which activates rolling motion of the wheeled foot 108 to skate.

The computing system utilizes processors to control autonomous navigation operations to travel about automatically changing from one operating mode function 1050 to another operating mode function 1050 to maneuver according to the operating environment.

In one implementation the head 102 being shaped like a human head and the front of the head is shown to encompass a virtual face monitor 102a. Accordingly the virtual face monitor 102a is removably connected to the head, as example in FIG. 1. The face monitor 102a is linked to a microphone 1320, speaker 1321 and as well, liked to various sensors 119, and cameras 120, 121, as exampled being disposed on the body 101 or on the head 102.

Wherein the computing system 1000 linking to control subsystems 1001-1050, 1060 via wiring configurations.

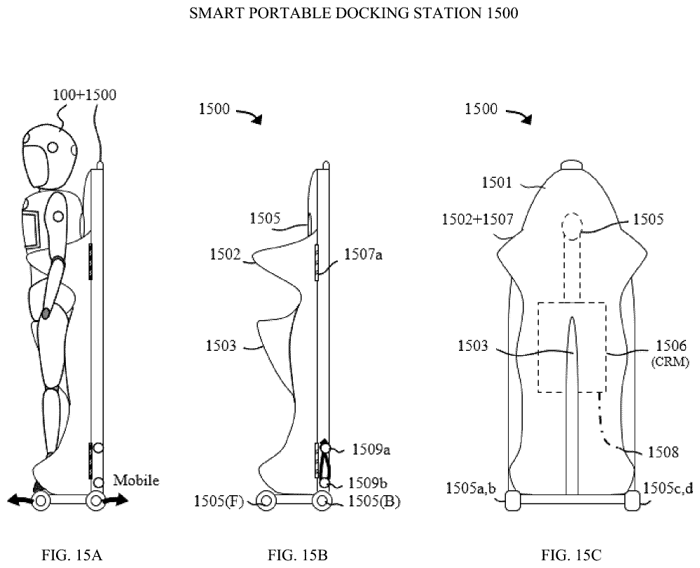

In greater detail FIG. 1A is a front view of the autonomous humanoid robot 100A and FIG. 1AA is a rear view of the autonomous humanoid robot 100A, as shown the body 101 comprises a charging module 1505(A). The charging module 1505(A) electronically links to a battery charging module 1505(B) is detailed further in FIG. 15.

Accordingly one or more LED lighting units 117/118 include head lights, tail, brake lights and turn signals, and can work as a flash light, wherein the LED lighting units may be affixed on the autonomous humanoid arm 103 to light up an object 116 being handled, or affixed or on autonomous humanoid legs 105 and on the fender 107, a front LED lamp 117, a rear LED lamp 118 to illuminate an operating environment 1600 of the autonomous humanoid robot 100.

Referring to FIG. 1AA as shown, the back side of the autonomous humanoid robot 100 may comprise one or more compartments with access doors, and a charging module 1505(A), see FIG. 1AA and FIG. 15, whichever power proving means is electrically linked to distribute power to one or more internal electric devices, or external electric devices, a processing device providing a communication link either wired or wireless connecting one or more electric devices to the battery power source, a USB port connectable with AC power supply for recharging battery of the autonomous humanoid robot 100, respectively, one or more removable batteries can be contained within the one or more battery compartments.

Accordingly, the upper portion 104 of the body is containing a compartment 112 for housing a control panel 114 and a computing system 1000, wherein the computing system 1000 is linking to the control panel 114. Wherein the computing system 1000, control panel, and body parts 101(BP) are electronically linked via wiring 111.

In various implementation the control panel connected outwardly exposing a touch screen 114a, when on, the touch screen 114a prompts a menu 114b for user 1101 to access various settings 114c, selections may include multimedia conferencing 114d, selecting virtual graphic 114e and access monitoring data received from the computing system 1000.

Wherein the bottom portion 101(B) containing a compartment 112 for housing at least one battery 113 and a charger, wherein the computing system 1000 linking to control subsystems 1000-1050 linking the at least one battery 113 to the body components 101, detailed in FIG. 1A-1AA.

Accordingly the control panel may include at least one microphone 1320 for user interface communication and at least one speaker 1321 associated with user interface communication; the at least one microphone 1320 and the at least one speaker 1321 linked to the computing system 1000.

Accordingly one or more compartments 112 are configured for housing computing system 1000 components, and housing the at least one battery 113 in which the at least one battery 113 is charged by external USB port, and wherein electrical wiring 111 is configured for linking battery power to the computing system 1000, then, to power components of the body 101.

The body 101 is further configured with an array of cameras 120, or a 3-D camera 121, which can include light sensors and configured with a plurality of external sensors which can include; proximity sensors 119, LIDAR 119(L) or RADAR 119(R), and an IMU 123 to measure acceleration (from which velocity can be calculated by integration), or other sensors to measure inclination like force sensors (e.g., in hands or tools), to measure contact force with environment 1600, position sensors to indicate position (from which velocity can be calculated by derivation). Accordingly, a plurality of internal motion sensors which may include gyros 124, or accelerometers 125. Accordingly exteroceptive sensors, e.g., cameras 120, 121 which can be used to simulate human touch, vision, hearing, sound sensors (e.g., microphone 1320 and audio speaker 1321), and other sensors like temperature sensors, contact sensors, an orientation sensor, an acceleration sensor, an angular velocity sensor. Accordingly the acceleration sensor and the angular velocity sensor are configured for directly measuring coordinates used for the controlling of a vector position of the joint axis orientation based on orientation sensor data. Accordingly, a calculation model provides a dynamic equation composed by an acceleration sensor and the orientation sensor, each are distributed and connected on a series of control points and are sequentially summed by the calculation model; the acceleration sensor, angular velocity sensor, orientation sensor, an acceleration sensor and dynamic equations control the orientation of the head 102 at the body's upper body 101(U).

In various elements, the waist module further securable relative to the main body, the waist module having a joint assembly adapted to pivot with at least two degrees of freedom relative to bending or twisting at a center portion of the body.

In various elements, the drive assembly secured to a hip portion 106a of the body, the swivel assembly adapted to cooperate with the swivel shafts to pivot the leg 105 with at least two degrees of freedom relative to the body.

In various elements, the plurality of perception sensors and cameras configured for detecting object 116 surrounding the autonomous humanoid robot, the sensors and cameras providing object data and image data to a computing system comprising a plurality of processors.

In various elements, one or more instructions initiated based on a battery storage level, a processor to activates a charging module configured to charge one or more batteries so that power is controlled, by the computing system, to engage and regulate velocity of the joint actuators and motors of the body.

In various elements, processors are configured for activating a charging module 1506A to charge one or more batteries so that power is controlled to regulate velocity of the joints of the body and the motor of the wheeled foot.

In various elements, the plurality of perception sensors and cameras configured for detecting object 116 surrounding the autonomous humanoid robot, the sensors and cameras providing object data and image data to a computing system comprising a plurality of processors.

In various elements, a computer-implemented control method configured for collecting posture information of posture sensors disposed on the body for estimating a first set of joint angular velocities of all joints of the autonomous humanoid robot according to a balance control algorithm; instructions for estimating a second set of joint angular velocities of all joints of the autonomous humanoid robot according to a momentum planning algorithm; instructions for estimating a third set of joint angular velocities of all joints of the autonomous humanoid robot according to a pose return-to-zero algorithm; and instructions for accomplishing pose control on the autonomous humanoid robot according to the first set of joint angular velocities, the second set of joint angular velocities, and the third set of joint angular velocities.

In various implementations, the plurality of cameras 120 are configured for real-time object detection, to capture surrounding imaging or to provide live video of an object 116 in an operating environment 1600, the 3-D cameras configured for real-time object detection and to capture surrounding imaging or providing video, the proximity sensors responsive to a proximity sensor input signal activated by a user's presence or live being, and the plurality of sensors 119-125 and other sensors for collision avoidance, to detect a user, to localize object 116 in an operating environment 1600. Accordingly a plurality of touch sensors 126 are responsive to a touch sensor input signals activated by a user's contact. Wherein the motion sensors IMU 123, gyros 124, accelerometers 125 are responsive to a motion sensor input signal activated by accelerometers and gyro sensors are associated with identifying or to localize motion parameters and provide dynamic data including roll, pitch, yaw angles, attitude and velocity of the body, and associated with stabilization of parameters including at least one of counteracting angles of the one or more joint mechanisms, servos, actuators, manipulators of the autonomous humanoid robot's body.

In various elements, the arms to provide at least two degrees of freedom of movement to expand or retract at multiple joint angles, such that the autonomous humanoid robot can perform various object 116 handling maneuvers to complete task by reaching out to grab an item.

In various elements, the legs to provide at least two degrees of freedom of movement for adjusting a pivoting action of a wheeled foot of the leg, such that the leg can withstand a surface impact.

In various elements, the waist module is configured to support the body and reposition bending motion of the body such that the autonomous humanoid robot can counter balance the body at center mass (CM) which allows the autonomous humanoid robot to maintain an upright position during operation.

In various elements, the drive assembly comprising a motor operatively associated with the shoulder joint, elbow joint and the wrist joint for independently driving pivotable movement for reaching to obtain an object 116; and each leg including a respective pivotal hip joint, a pivotal knee joint, and a wheeled foot adapted to step, walk or roll along a surface.

In various elements, the drive assembly comprising a motor operatively associated with the hip and knee joints and the wheeled foot for independently driving pivotal movement of the hip joint and the knee joint and rolling motion of the wheeled foot; and the waist module operatively associated with a joint providing yaw, roll, and pitch motion for counter balancing the body at CM.

In various elements, a balance control algorithm, and a momentum planning algorithm configured for estimating joint angular velocities of all joints of the autonomous humanoid robot according to a pose return-to-zero algorithm for one or more instructions initiated for accomplishing pose control on the autonomous humanoid robot according to a first set of joint angular velocities, the second set of joint angular velocities, and the third set of joint angular velocities such that the autonomous humanoid robot can step, walk, roll, skate, or perform acrobatic maneuvers to complete various task functions 1060.

In various elements, the arm rotatably coupled a shoulder independently pivoting the arm with at least two degrees of freedom relative to the body to accomplish reaching movement of the arm; wherein the shoulder joint and the pivotal elbow joint are simultaneously yet independently drivable by the motor to create forward and reverse motions relative to counter-balancing bending motions of the body such that the autonomous humanoid robot maintains balance.

In various elements, the hip joint of the leg rotatably coupled to a hip portion of the body, the hip joint for pivoting the leg with at least two degrees of freedom relative to the body to accomplish swiveling movement of the leg; and wherein the joints about which the leg may move relative to the body with at least two degrees of freedom of movement; and wherein the hip joint and the pivotal knee joint are simultaneously yet independently drivable by the motor to create forward stepping motion, reverse stepping motion, walking motion, jumping motions, or other humanlike maneuvers.

In various elements, the drive assembly further comprises a joints and joint sensors for imparting driving pivotal movement to the hip joint, pivotal movement the knee joint, and rolling motion to the wheeled foot, respectively to move at various steering directions.

In various elements, one or more instructions initiated driving process for accomplishing the motor to drive the pivoting movement of the knee joint 106b and the rolling motion of the wheeled foot 108.

In some embodiments, wherein the determining the expected rotation angle and the expected rotation angular velocity corresponding to each of the leg joint servos of leg of the humanoid robot based on the current rotation angle of each of the leg sub-joints comprises: determining the expected rotation angle and the expected rotation angular velocity corresponding to a left shoulder joint servo 104a based on the current rotation angle of a right servo shoulder joint 104a; determining the expected rotation angle and the expected rotation angular velocity corresponding to a left elbow joint servo 104b based on the current rotation angle of a right elbow joint 104b; determining the expected rotation angle and the expected rotation angular velocity corresponding to a left wrist joint servo 104c based on the current rotation angle of a right wrist joint servo 104c or end effector capable of panning and tilting via x, y, and z axis representative of tilting the end effector forward, backward, or sideward rotation, laterally whereby providing stability during handling activities.

In some embodiments, wherein the determining the expected rotation angle and the expected rotation angular velocity corresponding to each of the leg joint servos of leg of the humanoid robot based on the current rotation angle of each of the leg sub-joints comprises: determining the expected rotation angle and the expected rotation angular velocity corresponding to aa left hip joint servo 106a based on the current rotation angle of a right servo hip joint 106a; determining the expected rotation angle and the expected rotation angular velocity corresponding to a left knee joint servo 106b based on the current rotation angle of a right knee joint 106b; determining the expected rotation angle and the expected rotation angular velocity corresponding to a left ankle joint servo 106c based on the current rotation angle of a right ankle joint servo 106c or end effector capable of panning and tilting via x, y, and z axis representative of tilting the end effector forward, backward, or sideward rotation, laterally whereby providing stability during driving activities.

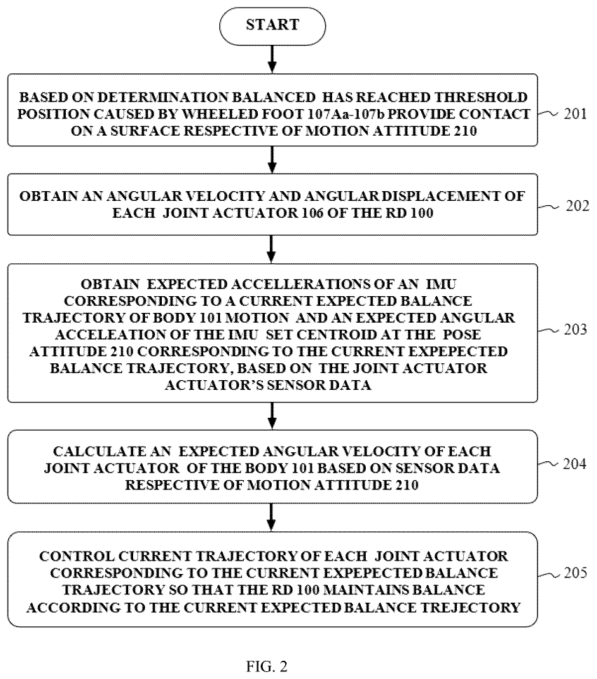

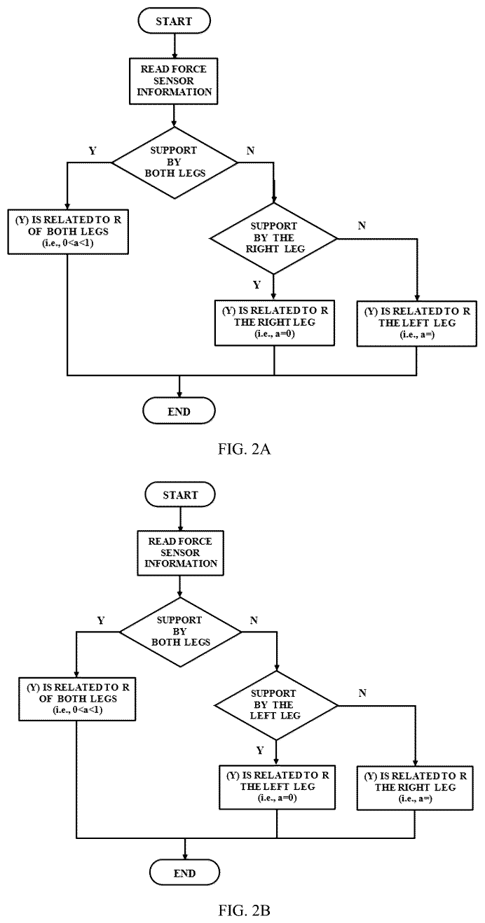

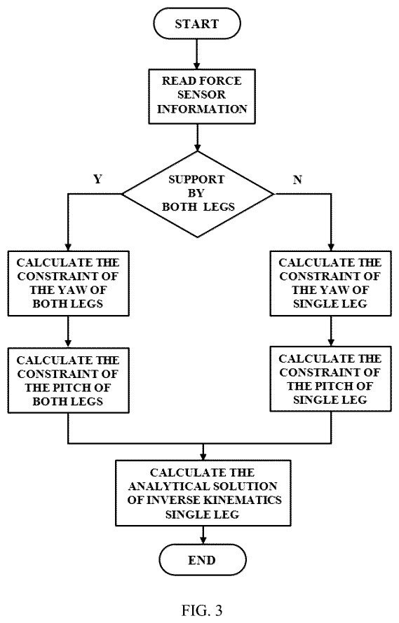

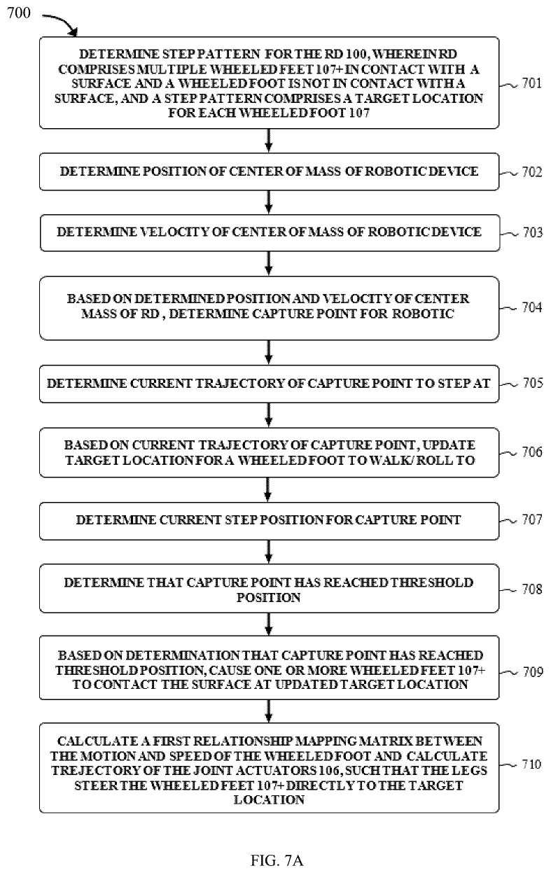

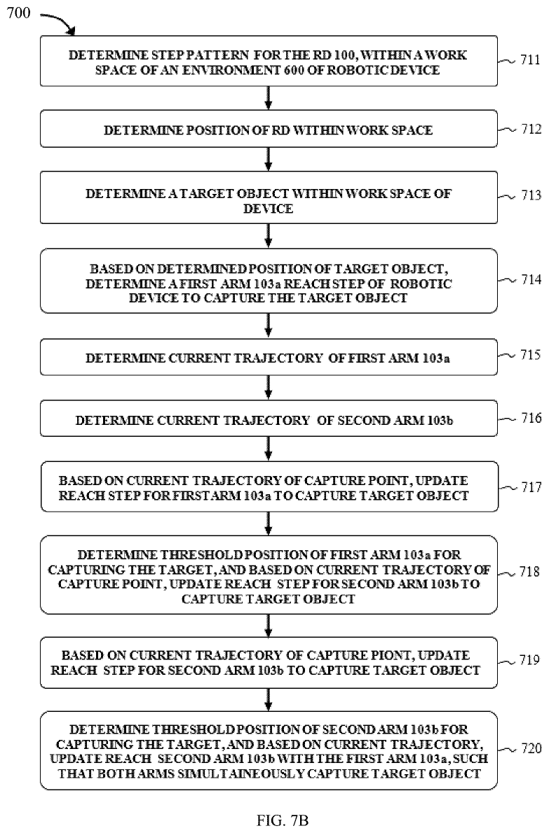

In greater detail FIG. 2, FIG. 2A-2B, FIG. 3 and FIG. 7A, 7B illustrate flow charts of a coordinate vector of the joint actuator axis of the operating environment 1600 includes robotic devices 13-106 (RD) respective the arm and the leg joint components detailed above, following steps are detailed herein.

Referring to FIG. 2 and FIG. 2 and FIG. 2B illustrate flowcharts of controllers the autonomous humanoid robot 100 sub steps S201-S205: constructing joint actuators 104/106 of body.

In this embodiment, a coordinate vector of the joint axis of the RD 103-106 can be constructed according to the following formula: THETA.=[.theta..sub.1,.theta..sub.2,.theta..sub.3,.gamma.].sup.T; (1).

where, .theta..sub.1 is an included angle (or the rotational primitive) between the inverted massless beam and a wheeled foot 108, .theta..sub.2 is the translational primitive of the inverted massless beam, and .theta..sub.3 is an included angle between the momentum wheeled foot 108 sub steps, and the inverted massless beam, gamma. is an included angle between the wheeled foot 1078 and a horizontal plane, and THETA. is the coordinate vector of the joint axis.

S202: constructing a balance state of the centroid I of the middle section between the upper body section 101Ua and the lower body section 101Bb of the body 101 based on IMU data.

The purpose of constructing the RD 103-106 lies in the two control objectives of the centroid state and the posture state. Therefore, the balance state of the RD 103-106 can be defined mainly for these two control objectives. In this embodiment, a coordinate vector of the balance state of the RD 103-106 is constructed according to the following formula: .PHI.=[.phi..sub.1,.phi..sub.2,y.sub.com,z.sub.com].sup.T; (2).

where, .phi..sub.1 is an included angle between the inverted massless beam of the RD 103-106 and the z-axis of a Cartesian coordinate system, .phi..sub.2 is the posture of the momentum wheel of the RD 103-106 in the Cartesian coordinate system, and y.sub.com and z.sub.com are the positions of the waist 111 via servo 112 in the Cartesian coordinate system, PHI. is the coordinate vector of the balance state of the RD 103-106 to simultaneously cause autonomous balancing actions of the body 101.

It is worth noting that, if it needs to control the state of the posture, the information of .phi..sub.2 can be directly used. If it needs to control the state of the waist 111 based on IMU 112 calibrations, either y.sub.com and z.sub.com can be directly used, or the centroid can be controlled by controlling the states of .phi..sub.1 and .theta..sub.2, because there is a relationship shown in formulas (3a) and (3b): z.sub.com=.theta..sub.2 sin(.phi.1); and (3a) y.sub.com=.theta..sub.2 cos(.phi.1) (3b).

In terms of quality attributes, the masses of the links of the RD 103-106 can be summed up to form the mass of the momentum wheel, as shown in formula (4): M=i=1 n.times. m i; (4) ##EQU00001 ##.

where, M is the mass of the momentum wheel, n is the number of the joints of the RD 103-106, and m.sub.i is the mass of the joint i (1.ltoreq.i.ltoreq.n) of the RD103-106.

The position of the centroid of the simplified momentum wheel inverted pendulum can be calculated based on the fitted centroid formula which, taking the y-axis as an example, is as shown in formula (5):.times. y.times. ?=i=1 n.times. m i.times. y i M; times. .times. ? .times. indicates text missing or illegible when filed (5) ##EQU00002 ##, where, y.sub.i is the coordinate of the centroid of the joint i of the RD 103-106.

The inertia of the simplified momentum wheel inverted pendulum can be obtained through the parallel axis theorem by shifting the inertia of each joint of the RD 103-106 to the centroid coordinate system so as to add up as follows: I=i=1 n.times. I ci; (6) ##EQU00003 ##.

where, I.sub.ci is the inertia tensor matrix after the inertia tensor matrix of the joint i is shifted to the fitted centroid. In which, the shifting method of the inertia moment which, taking the y-axis as an example, is as shown in formula (7): I.sub.ci.sup.yy=I.sub.gi.sup.yy+m.sub.i(x.sub.i.sup.2+z.sub.i.sup.2).

where, I.sub.gi is the inertia tensor of the joint i of the RD 103-106 centered on the centroid and aligned with each axis of the Cartesian coordinate system, the superscript yy represents the y-axis moment of inertia, and x.sub.i is the distance in the x direction from the centroid of the joint i of the RD 103-106 to the fitted centroid, and z.sub.i is the distance in the z direction from the centroid of the joint i of the RD 103-106 to the fitted centroid.

The shifting method of the product of inertia which, taking the xy axis as an example, is as shown in formula (8): I.sub.ci.sup.xy=I.sub.gi.sup.xy+m.sub.ix.sub.iy.sub.i.

where, the superscript xy represents the product of inertia of the x-axis and the y-axis, and y.sub.i represents the distance in the y direction from the centroid of the joint i of the RD 103-106 to the fitted centroid: mapping a joint axis of the RD 103-106 to the joint axis of the RD 103-106 via forward kinematics.

The forward kinematics algorithm from the joint space of the RD 103-106 to the balance state of the RD 103-106 also needs to be implemented through a rotation matrix. First, the rotation matrix of .PHI..sub.1 can be expressed as: R.sub..PHI..sub.1=R.sub.footR.sub.root.

Similarly, the rotation matrix of .PHI..sub.2 can be obtained, R.sub..PHI..sub.2=R.sub..PHI..sub.1R.sub.wheeled foot 108.

Then, in a similar way to formulas (12a) and (12b), the respective angles can be obtained through the function a tan 2( ). The position of the centroid can be obtained based on formulas (3a) and (3b); S203: mapping the balance state of the joint axis of the arms 103-104, of the joint axis of the legs-105-106, compared to the joint axis of the waist 111 via inverse kinematics.

As shown in FIG. 3 after the state control of the centroid and posture is performed in the balance state of the RD 103-106, the reference value needs to be returned to the joint axis of the RD 103-106, and then further mapped to the joint axis of the autonomous humanoid robot 100. The inverse kinematics algorithm from the balance state of the RD 103-106 to the joint axis of the RD 103-106 is the inverse of each formula in step S204. The rotation matrix of .theta..sub.3 can be expressed as: R.sub.wheel=R.sub..PHI..sub.2R.sub..PHI..sub.1.sup.T (20).

The rotation matrix of the joint angle .theta.1 of the RD 103-106 can be expressed as: R.sub.root=(R.sub.foot.sup.TR.sub..PHI..sub.1).sup.T=R.sub..PHI..sub.1.s-up.TR.sub.foot (21).

The joint angle .theta..sub.2 of the RD 103-106 is the distance from the fulcrum to the centroid, and gamma. is generally uncontrollable.

S205: mapping the joint axis of the RD 103-106 of the autonomous humanoid robot 100 via inverse kinematics estimated via computing system 1000 processes detailed herein.

In greater detail FIG. 3 illustrate a flowchart of calculating the current rotation angle of each of the leg sub-joints based on the pose relationship corresponding to the leg sub-joint, the method further comprises: obtaining an initial rotation angle of each of the leg sub-joints; the determining the expected rotation angle and the expected rotation angular velocity corresponding to each of the leg joint servos of leg of the humanoid robot based on the current rotation angle of each of the leg sub-joints comprises: determining the expected rotation angle and the expected rotation angular velocity corresponding to each of the leg joint servos of leg of the humanoid robot based on the initial rotation angle and the current rotation angle of each of the leg sub-joints. Wherein the optimization object drive function is created based on a stability theory of an extrapolated centroid XCoM through an equation of (.theta..sub.2,\acute{.theta.}.sub.2)=1/2.parallel.b-s.parallel..sup.2; where b=(b.sub.x,b.sub.y) is a position of the extrapolated centroid XCoM, s=(s.sub.x,s.sub.y) is a position of a center of a support boundary BoS, .theta..sub.2 is the corrected expected rotation angle of the target optimized joint servo, and \check{.theta.}.sub.2 is the corrected expected angular velocity of the target optimized joint servo.

In some embodiments, wherein the optimizing the second expected rotation angle and the second expected rotation angular velocity of the one or more target optimized joint servos based on the optimization object drive function to obtain a corrected expected rotation angle and a corrected expected rotation angular velocity of the one or more target optimized joint servos comprises: obtaining the position of the extrapolated centroid XCoM and the position of the center of the support boundary BoS; calculating the optimization object drive function based on the position of the extrapolated centroid XCoM and the position of the center of the support boundary BoS to obtain a first iterative formula of the expected rotation angle of the target optimized joint servo and a second iterative formula of the expected rotation angular velocity of the target optimized joint servo; and calculating the corrected expected rotation angle based on the first iterative formula of the expected rotation angle of the target optimized joint servo, and calculating the corrected expected rotation angular velocity based on the second iterative formula of the expected rotation angular velocity of the target optimized joint servo.

In some embodiments, wherein the instructions for controlling each of the leg joint servos of the autonomous humanoid robot based on the first expected rotation angle and the first expected rotation angular velocity of the one or more non-target optimized joint servos 104/106 and the corrected expected rotation angle and the corrected expected rotation angular velocity of the one or more target optimized joint servos comprise: instructions for obtaining a first actual rotation angle of the one or more non-target optimized joint servo and a second actual rotation angle of the one or more target optimized joint servos through a joint encoder of the autonomous humanoid robot; instructions for calculating, using a sliding mode controller, a first reference velocity of the one or more non-target optimized joint servos based on the first actual rotation angle, the first expected rotation angle and the first expected rotation angular velocity of the one or more non-target optimized joint servos; instructions for calculating, using the sliding mode controller, a second reference velocity of the one or more target optimized joint servos based on the second actual rotation angle, the corrected rotation angle and the corrected rotation angular velocity of the one or more target optimized joint servos 104/106; and instructions for controlling each of the leg joint servos of the humanoid robot based on the first reference velocity of the one or more non-target optimized joint servos and the second reference velocity of the one or more target optimized joint servos.

Referring to FIG. 4 the autonomous humanoid robot 100 includes head 101 having a preferred shape constructed with virtual display generate eyes, a nose and an articulated month. In various implementations the head 102 can be configured with facial actuators to make facial feature expressions with moving eyes, nose, mouth, lips, wherein the facial actuators can be electric servos or other mechanical components.

Referring to FIG. 4 the autonomous humanoid robot 100 includes at least one left arm 103a and at least one robotic right arm 103b each having an end or effector 104(E) configured for an adjustment operation to adjust at least one position and direction of a manipulator implement such as a hand 103(H), a gripper 103(G), a suction device such as a suction cup 103(SC), or other handheld implements which can be heavy duty tools.

Referring to FIG. 4 the autonomous humanoid robot 100 includes at least one left leg 105a and at least one robotic right leg 105b each having an end or effector 106(E) configured for an adjustment operation to adjust at least one position and direction of a fender 107 segment covering the wheeled foot 108, the wheeled foot's motor 109 assembly provides fore and aft velocity and a braking arrangement and wherein the upper boot portion providing LED lighting 117/118.

In greater detail FIG. 5 is an illustration of the waist module 111 including the actuating servo 112 constructed for accomplishing one or more of the following actions involving reaching outwardly, upwardly, downwardly and backwardly, wherein waist module 111 is constructed for accomplishing actions involving flexing forward, flexing backward and flexing sideways at the waist. Accordingly the hip joint portion can accomplish forward or rearward pelvic thrust for raising the height of the autonomous humanoid legs 107. The body 101 area is protected by exoskeleton which includes a front, a back, and sides extending outwardly, the front and back may include a protruding groin and buttocks. The frame construction with power-driven manipulators providing a rotatable connection between an upper portion and a bottom portion of the body, and altering the height and pitch angles of a waist such that autonomous humanoid robot maneuvers similar to how a human physically maneuvers her/his waist.

The actuating servos 112 having a less complicated lateral joint construction with power-driven manipulators utilizing one or more joint mechanisms, servos, actuators provided a rotatable connection between the upper portion 101(U) and the bottom portion 101(B) of the body thusly altering the height and pitch angles of a waist such that autonomous humanoid robot maneuvers similar to how a human physically maneuvers her or his waist.

As shown FIG. 5A is a diagram of the X-axis, Y-axis and Z-axis providing the dynamic data of roll, pitch, yaw of the multiple joint angles.

In various aspects the modular fulcrum torso module 200 of the autonomous humanoid robot 100 offers autonomy for controlling maneuvers of the novel modular fulcrum spine to heterogeneous bend on the flexing at the upper portion 101(U) and bottom portion 101(B) detailed herein: an actuating waist module 111 providing multi-axis degree movement 113 to bend the upper portion 104 forward or to bend the upper portion 104 backward, example motion is an arrow, respective of FIG. 8A.

Still referring to FIG. 5, the joint servos 112 of the actuating waist 202 is configured for providing multi-axis degree movement to bend the upper portion 101U sideward to oppose the bottom portion 101B. Respectively, the waist includes the IMU, gyros, accelerometers configured to localize motion trajectory and provide dynamic data of yaw (Z) roll (X), pitch (Y) of the multiple joint angles, respectively the servo 112 causes yaw axis motion to pivot the section between the upper and bottom portions of the body 101.

A balance control algorithm 1001(BCA), and a momentum planning algorithm 1001(MPA), in a motion or position application, are configured for estimating joint angular velocities of all joints of the autonomous humanoid robot according to a pose return-to-zero algorithm.

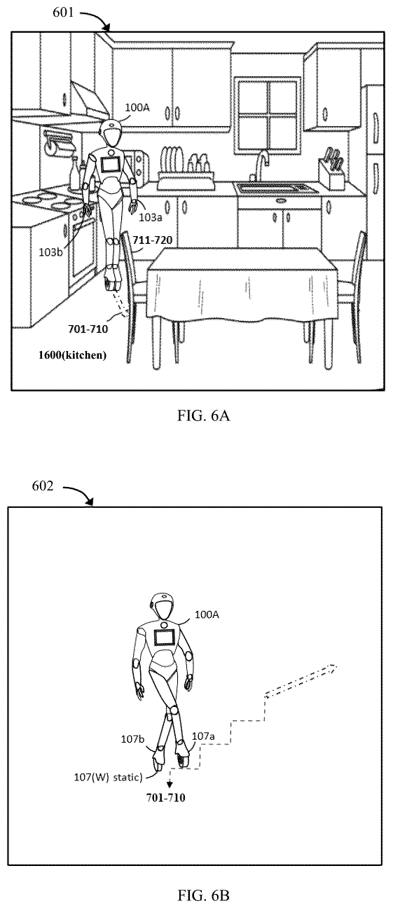

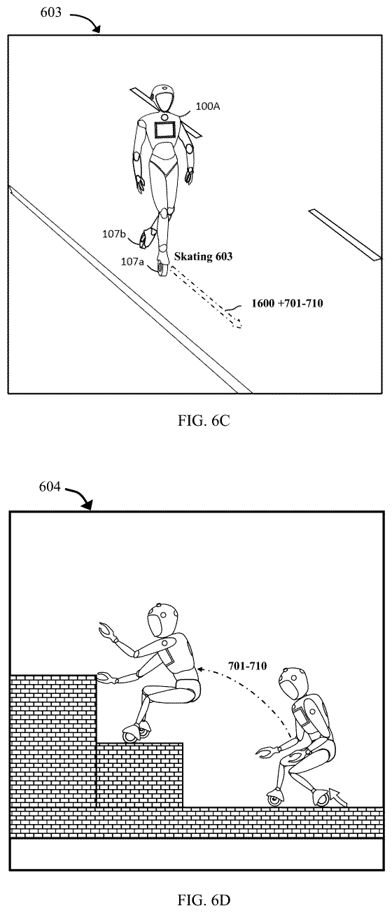

In greater detail FIG. 6A is an illustration of the autonomous humanoid robot 100 accomplishing a series of maneuvers for skating, as shown the autonomous humanoid robot is actively working in a kitchen setting of an operating environment 1600.

In greater detail FIG. 6B is an illustration of the autonomous humanoid robot 100 accomplishing a series of maneuvers for skating, as shown the autonomous humanoid robot is actively stepping up stairway setting of an operating environment 1600.

In greater detail FIG. 6C is an illustration of the autonomous humanoid robot 100 accomplishing a series of maneuvers for skating, as shown the autonomous humanoid robot is actively skating on a roadway setting of an operating environment 1600.

In greater detail FIG. 6D is an illustration of the autonomous humanoid robot 100 accomplishing a series of maneuvers for leaping or jumping 804, as shown the autonomous humanoid robot is actively jumping up and over an obstacle setting of an operating environment 1600.

In greater detail FIG. 7A and FIG. 7B are schematic block diagrams of the computing system 1000 to determine a series of sub steps 701-710 respective of sub steps; S201, S202, S203, S204, S205 of FIG. 2, calibrating motion and position altering the height and pitch angles of the arms 103, 103b and the legs 105a, 105b, respectively the autonomous humanoid robot 100 to determine step pattern for the HR 100.

In greater detail FIGS. 8A-FIG. 8G perceptively show various physical maneuver's include but are not limited to; balancing 801, standing 802, stepping 1^{st} and walking 803 2^{nd}, jumping 804, acrobatics 805 to play sports or perform dance moves and perform other entertainment, crawling 806, kneeling 807, and fall recovery sub steps involving a series thereof to become upright.

In various elements, the computing system processor to execute a command process to maneuver the autonomous humanoid robot into one or more unique pose maneuvers, such that the autonomous humanoid robot can reposition body parts to achieve a series of steps; Step 1-Step 5, as exampled in FIG. 8G. Respectively, the fall recovery mode 1056 involving a sequence of actions exampled as fall recovery maneuvers 808 changing from a prone position into a semi-prone position then, changing from a semi-prone position into a squatting position into a lateral bowed position then, changing from a semi-bowed position into a leaning-upright position then, changing from a leaning-upright position into an upright-standing position

In greater detail FIG. 9A and FIG. 9B illustrate the autonomous humanoid robot 100 performing involving is bending completely forwards such that the autonomous humanoid robot 100 can haul payloads (like a mule or like a vehicle) or be ridden by a user 1101.

Accordingly in some implementations the autonomous humanoid arm 107 may be oriented at an oblique angle relative to facilitate dexterity and relative to balance control of the body 101, and both autonomous humanoid arms forcefully extend relative to a preferred pitch axis for repositioning a pose motion 1006 of the body 101, and/or both autonomous humanoid arms forcefully swing or reach in any direction to counter-balance the body 101 of the autonomous humanoid robot 100.

In even greater detail FIG. 9A illustrates maneuvers to transport a payload or an object 116, and achieve one or more of the following functions to perform a vehicle-like mobility service to carry a payload 901 as exampled in FIG. 9A, a ride-on vehicle 902 as exampled in FIG. 9B, to perform a delivery service 903, as exampled in FIG. 9C, and to perform a mule or a towing-vehicle 904,exampled as controlled pose maneuvers 1007 associated with motion control algorithms in FIG. 10.

In greater detail FIG. 10 is a chart detailing a computing system 1000 having one or more processors 1001, memory 1002, computer program 1003 and applications 1003 instruction 1004, the computing system's processors 1001 provide coding and software programming 1005 providing methodology for controlling the motion 1006 of an autonomous humanoid robot 100 such that the autonomous humanoid robot 100 can physically move similar to how a human physically moves to reposition pose maneuvers 1007, dynamic data of roll, pitch, yaw 1008 to perform stunts for entertaining users or to mimic physical attributes of a user 1101, motion parameter 1010 data; motion trajectory data 1011, external storage device 1012, a steering controller 1013 to control localize motion trajectory via an interactive autonomous humanoid robot interface subsystem 1200 associated with a basic application program (hereinafter also referred to as a “basic application”).

The memory 1002 may be an internal storage unit of the HR 100, for example, a hard disk or a memory of the HR 100. The memory 202 may also be an external storage device of the HR 100, for example, a plug-in hard disk, a smart media card (SMC), a secure digital (SD) card, flash card, and the like, which is equipped on the HR 100. Furthermore, the memory 202 may further include both an internal storage unit and an external storage device 1012 of the HR 100. The memory 1002 is configured to store the computer program 1003 and other programs and data required by the HR 100. The memory 1002 may also be used to temporarily store data 1009 that has been or will be output.

The autonomous humanoid robot comprising control methodology for further comprising instructions 1016 for generating modulated control signals 1021 of the one or more power-driving wheeled feet 108L, 108R based on a motion parameter 1010 data; motion trajectory data 1011 the microprocessors 1014(MP) for generating modulated control signals 1017 of the one or more joint mechanisms, servos, actuators IMU 123, gyros 124, accelerometers 125 configured to localize motion trajectory 1013 and provide dynamic data of roll, pitch, yaw 1008 of one or more joint mechanisms 104/106 based on a motion parameter 1020(P) utilizing GPS 1021 with remote or local path mapping 1021(M) associated with various perimeter tags 1021(T) and wherein the modulated control signals 1017 are transmitted to the computing system 1000 for controlling force 1020(F), rotational speed 1020(V) of the one or more joint mechanisms, servos, actuators, or manipulators 500.

The computing system utilizing a wireless communication system 1023 associated with I/O devices Wi-Fi 1024, Internet 1025, Bluetooth 1026, and cloud management 1027 linking to Internet of Things (IoT) 1028 and others like IoTs fog, IoT autonomous humanoid robot 100; and smart external devices; a smartphone 1030 with APPS, tablets/PC computer 131.

The computing system and software programming 1031 providing processors 1013 for controlling the motion parameter 1020 of an autonomous humanoid robot such that the autonomous humanoid robot can physically move similar to how a human physically moves to reposition pose, perform stunts for entertaining users or to mimic physical attributes of a user based on motion parameter 1020 and data 1018.

In various implementations, the computing system 1000 of the autonomous humanoid robot 100 is configured for managing handling operations 1014 and/or driving operations 1015 in operating environments 1600 such as game play environments 1600(GP), working at home and commercial work involving; fulfillment warehouse picking, manufacturing, delivery, shopping, retail sales, medical, safety, recovery, military, exploration, agriculture, food service involving food preparation, cooking, packaging, cleaning, and other occupations 1049(0).

In various aspects the computing system 1000 is associated with the control panel's the touch screen 114a prompts a menu 114b for user 1101 and to provide instructions allowing the user 1101 to access various settings 114c, selections include multimedia conferencing 114d, selecting virtual graphic 114e and access monitoring data received from the computing system 1000.

In various aspects the computing system 1000 can also include planning and control functionality to simulate human-like movement 1020(HLM) based on an operating mode function 1050, including legged locomotion with a humanoid gait.

Simulating human-like movement can include stabilization on a walking surface, exampled in FIG. 1C, and maintaining center of gravity over the center or center mass (CM) of bearing area for providing a stable position. Other aspects of motion parameter 1019 involve include maneuvers 1020A-1020 H.

The computing system utilizing one or more control signals 1021 being associated with a plurality of training sets 1021(TS) configured to execute a degree axis of rotation of one or more joint mechanisms, servos, actuator; to execute a degree axis of rotation of one or more joint mechanisms, servos, actuators; to accomplish maneuvering actions of a steering controller 1013, a propulsion controller, a brake controller; one or more control signals 1021 being associated with a plurality of training sets configured to execute a steering controller, a propulsion controller, a brake controller all associated with the computing system processors 1014 and microprocessors 1014(MP); one or more control signals 1017 being associated with a plurality of training sets 1021(TS) configured to execute a degree axis of rotation 1022 of one or more joint mechanisms, servos, actuators; one or more control signals being associated the control panel 114 vis one or more control signals 2017 routing through the computing system 1000, each being associated with a control panel 114, the control panel 114 having touch display for displaying an articulated hierarchical menu listing a variety of task functions 1060 associated with selecting real time operating mode function 1050.

The autonomous humanoid robot comprising methodology for an input manager 1037 for user input in obtaining said data from said input devices, calibrating movements detected in said physical space domain 1033 corresponding coordinates in said physical space 1049, and converting said data 1018 into an input frame representing a coherent understanding of said physical space domain and the action of said user 1101 within said physical space domain 1033 or motion parameter 1020; a knowledge base 1038, for storing physical space domain data 1033(D), including action inputs by the user within and in relation to said physical space domain 1033, and for further storing actions by the autonomous humanoid robot 100 within the physical space; a discourse model 1039 that contains state information about a dialogue 1039(D) with said user; an understanding module 1040 for use in receiving inputs from the input manager 1037, accessing knowledge about the domain inferred from the current discourse, and fusing all input modalities into a coherent understanding of the user's environment; a reactive component for receiving updates 1041 from the input manager 1037 and understanding module 1040, and using information about the domain and information inferred from the current discourse to determine a current action for said autonomous humanoid robot 100 to perform a motion 1020; a response planner 1042 for use in formulating plans or sequences of actions; a generation module 1043 for use in realizing a complex action request 1045 from the reactive component by producing one or more coordinated primitive actions, and sending the actions to an action scheduler for performance motion(PM); and, an action scheduler 1044 for taking multiple action requests from the interactive reaction 1046 and generation modules 1043 and accomplishing out said requests.

The autonomous humanoid robot further comprising: a multi-modal input 1047, for use in accepting data 1017 via user interface 1011 that allows a user (UI) to communicate with the autonomous humanoid robot 100 in an interactive reaction 1046, comprising: a control panel 114, for use in displaying to the user 1101 a visible representation of a computer generated operating environment 1600, including an animated autonomous humanoid robot 100(A) therein; a multi-modal input 1047, for use in accepting data 1017 defining a physical space domain 1033 distinct from said operating environment 1600, said physical space domain including the physical space 1033 occupied by the user and the visible representation or image 1048 of said operating environment 1600; a knowledge base, for use in mapping physical space domain data 1033, and actions by the user within the physical space domain, to an interaction with the operating environment 1600, and for mapping 1021(M) via actions by the autonomous humanoid robot 100 within the operating environment 1600 to said visible representation 1048, such that when displayed on the control panel 114 the actions of the autonomous humanoid robot 100 are perceived by the user as interacting with the physical space 1049 occupied by the user; and an operating environment 1600.

The autonomous humanoid robot comprising methodology for a response processor 1047(RP), that integrates deliberative and reactive processing performed on user inputs 1037 received by said multi-modal input 1047, wherein said response processor 1047(P) includes a scheduler 1047(S) for scheduling an appropriate system response based on an understanding of said physical space domain 1033 and actions of the user 1101, a discourse model 1047(DM) based on the retrieved inputs 1037, a tagged history of speech and voice of said user, and a response planner 1042 for identifying said discourse model 1047(DM) with at least one of a topic under conversation between said user 1101 and said operating environment 1600; wherein said response processor 1047(RP) further includes a deliberative component and a reactive component, wherein said deliberative component is configured to fuse portions of the user inputs into a coherent understanding of the physical space and actions of the user, updating a discourse model 1047(DM) reflecting current and past inputs retrieved from the user, and outputting to the reactive component 1041 a frame describing the user inputs 1037, and, wherein said reactive component 1041 is configured to receive updates of user inputs and frames concerning the user inputs from said deliberative processing, accessing data from a knowledge base about said domain and about a current discourse between the user, physical space, and physical space, and determining a current action for the physical space; wherein the multimodal input comprises multiple input channels each configured to capture at least one of said user inputs, and an input manager configured to integrate the user inputs 1037 from said multiple input channels and provide said integrated user 1101 inputs 1037 to said deliberative processing component 1047(PC); wherein the multiple input channels include at least one of speech, body position, gaze direction, gesture recognition, keyboard, mouse, user ID, and motion detection channels; wherein each of said multi-modal input, said deliberative processing, and said reactive processing operate in parallel; wherein said reactive processing provides reactive output to said output mechanism immediately upon receiving a predetermined input from said input device; wherein said reactive processing provides reactive output to said output mechanism upon receiving a predetermined input from said deliberative processing; wherein said predetermined input is speech by a user 1101; and, said reactive output is a command to initiate a conversational gaze on said autonomous humanoid robot 100; wherein said deliberative processing component comprises: an understanding module 1040 configured to fuse inputs from said multi-modal input and determine a coherent understanding of a physical space of the user and what the user is doing; a response planner 1047(P) configured to plan a sequence of actions based on said coherent understanding; and, a response generation module 1044 configured to implement each real time response and complex action formulated by said reactive component, wherein said multiple output device or output channel 1024(OC) include at least one channel 1024( )C) configured to transmit a speech stream input by said user, and at least one channel 1024(OC) configured to transmit any combination of at least one additional user input, including, body position, gaze direction, gesture recognition, a motion detection; and said deliberative processing component 1051 includes a relation module configured to relate at least one of the additional user inputs to said speech stream.

The user interface comprising an action scheduler that controls said autonomous humanoid robot 100 according to said real time responses 1052 and said complex actions in a manner that interacts with said user, wherein said response generation module 1044 initiates parallel operations of at least one of said responses by said autonomous humanoid robot 100, wherein the initiated parallel operations 1053 include at least one of speech output by said autonomous humanoid robot 100, an action performed by said autonomous humanoid robot 100, and task to be performed on said computing system, the user interface comprising an action scheduler 1054 that controls an animation that displays said interface in a manner that interacts with said user and performs actions requested via said user inputs, wherein the user inputs 1037 include at least one of speech 1037a, gesture 1037bs, orientation 1037c, body position 1037d, gaze direction 1037e, gesture recognition 1037f, user ID, 1037g and motion detection 1037h; said deliberative processing 1055 utilizes at least one of said user inputs 1037 to implement a complex action 1056; and, said reactive processing formulates a real time response 1057 to predetermined of said user inputs; wherein said deliberative processing 1055 component includes, as part of said deliberative processing; a multi-modal understanding component 1057 configured to generate an understanding of speech and associated non-verbal of said user inputs; a response planning component 1058 configured to plan a sequence of communicative actions 1061 based on said understanding, and, a multi-modal language generation 1059 component configured to generate sentences 1060 and associated gestures applicable to said sequence of communicative actions 1061.

The autonomous humanoid robot comprising user interface 1100 methodology for allowing a user 1101 to interface with a computing system 1000, comprising sets: displaying to the user 1101, using a control panel 114, a visible representation of a computer generated operating environment 1600, including an animated autonomous humanoid robot 100 therein; accepting, using a multi-modal input 1057a, data 1057b defining a physical space domain 1057c distinct from said operating environment 1600, said physical space domain 1033 including the physical space occupied by the user and the visible representation of said operating environment 1600; mapping in a knowledge base 1059, physical space domain data 1033(D), and actions by the user within the physical space domain, to an interaction with the operating environment 1600, and for mapping actions by the autonomous humanoid robot 100 within the operating environment 1600 to said visible representation, such that when displayed on the control panel 114 the actions of the autonomous humanoid robot 100 are perceived by the user 1101 as interacting with the physical space 1033 occupied by the user; and, generating, using a response processor 1012, in response to a user 1101 input to the autonomous humanoid robot 100, an action to be performed by said autonomous humanoid robot 100, including the sub-steps of, interpreting said user input data and said physical space information data 1033(D) and generating a user input context associated with said input, determining a system response 1012 in response to said user input and said user input context, wherein said step of determining a system response includes the steps of formulating real time responses to a predetermined set of said inputs by reactive processing; and, formulating complex actions based on said inputs by deliberative processing; and, wherein said deliberative processing 1013(D) includes the steps of determining an understanding 1066 of said physical space domain and actions of the user, scheduling 1044 an appropriate response based on said understanding, updating a discourse model based on the retrieved inputs, and communicating said understanding to said reactive processing; wherein said step of determining an understanding, comprises the steps of: combining selected of said inputs into a frame providing a coherent understanding of said physical space domain and actions of said user, including the steps of, accessing a static knowledge base about a physical space domain with reference to said selected inputs; accessing at least one of a dynamic knowledge base and a discourse model to infer an understanding of a current discourse between said user and said operating environment 1600; accessing a discourse model to infer an understanding of said current discourse; and, combining information from at least one of said static knowledge base, said dynamic knowledge base, and said discourse model to produce said frame.

The autonomous humanoid robot interface 1400 for allowing the autonomous humanoid robot 100 to interface with a user 1101, the fusing includes the steps of: identifying a user 1101 gesture 1054 captured by said inputs; and, determining a meaning of a user 1101 speech and voice captured at least one of contemporaneously and in close time proximity of said user gesture 1051; generate scheduling 1052 an appropriate system response based on said understanding; and, updating a discourse model 1055 based on the retrieved inputs and updating inputs; maintaining a tagged history 1054 of speech or voice of said user by identifying 1053 said discourse model 1055 with at least one of a topic under conversation 1056 between said user and said operating environment 1600 and other information received via either of said deliberative 1057 and reactive processing 1058; GPS mapping in a knowledge base 1059 by maintaining information identifying 1060 where said user is located within said physical space domain; or, maintaining information identifying at least one of a position 1060 and orientation 1061 of at least one of a character 1062 and object 116 displayed in said operating environment 1600; and, tracking placement in a plan 1064 being implemented by a programming of said operating environment 1600; receiving asynchronous updates 1065 of selected of said user inputs and understanding frames 1066 concerning said user inputs from said deliberative processing 1013(DP): accessing data from a static knowledge base 1067 about said physical space domain and a dynamic knowledge base 1067 having inferred information about a current discourse between said user, said physical space domain, and said operating environment 1600 and, determining a current action for said operating environment 1600 based on said asynchronous updates 1069, understanding frames, and said data, wherein said understanding module 1040, said response planner, and said generation module are included within a deliberative component; wherein said reactive component and said deliberative component are included within a response processor 1012.

The processor 1001 processes or trains cameras 120, 121 bundled with one or more of an OTS, encoder, IMU, gyro, one point narrow range sensor 119, etc., and a three- or two-dimension LIDAR for measuring distances as the autonomous humanoid robot 100 moves. On example may include an autonomous humanoid robot 100 including a cameras 120, 121, a LIDAR, and one or more of an OTS, encoder, IMU, gyro, and one point narrow range sensor 119. A database of LIDAR readings which represent ground truth may be stored and a database of sensor 119 readings may be taken by the one or more of OTS, encoder, IMU, gyro, and one point narrow range sensor 119. The processor 1001 of the autonomous humanoid robot 100 may associate the readings of the two databases to obtain an associated data and derive a calibration. In some embodiments, the processor 1001 compares the resulting calibration with the bundled cameras 120, 121 data and sensor 119 data (taken by the one or more of OTS, encoder, IMU, gyro, and one point narrow range sensor 119) after training and during runtime until convergence and patterns emerge. Using two or more cameras 120, 121s or one cameras 120, 121 and a point measurement may improve results.

In some embodiments, the autonomous humanoid robot 100 navigates around the environment and the processor 1001 generates map using sensor 119 data collected by sensors 119 of the autonomous humanoid robot 100. In some embodiments, the user may view the map using the application and may select or add object(s) 116 in the map and label them such that particular labelled object 116 are associated with a particular location in the map. In some embodiments, the user may place a finger on a point of interest, such as the object 116, or draw an enclosure around a point of interest and may adjust the location, size, and/or shape of the highlighted location.

The autonomous humanoid robot 100, wherein the object 116 dictionary is generated based on a training set comprising images of examples of pre-labeled object 116.

In some embodiments, the processor 1001 combines new sensor 119 data corresponding with newly discovered areas to sensor 119 data corresponding with previously discovered areas based on overlap between sensor 119 data. A work space 1600(WS) may include a mapped area, an area that has been covered by the autonomous humanoid robot 100, and an undiscovered area. After covering the covered area, the processor 1001 of the autonomous humanoid robot 100 may cease to receive information from a sensor 119 used in SLAM at a first location. The processor 1001 may use sensor 119 data from other sensors 119 to continue operation. The sensor 119 may become operable again and the processor 1001 may begin receiving information from the sensor 119 at a later location, at which point the processor 1001 observes a different part of the work space 1600(WS) than what was observed at the first location. A work space 1600(WS) may include an area observed by the processor 1001, a remaining undiscovered area, and unseen area. The area of overlap between the mapped areas and the area observed may be used by the processor 1001 to combine sensor 119 data from the different areas and relocalize the autonomous humanoid robot 100. The processor 1001 may use least square method, local or global search methods, or other methods to combine information corresponding to different areas ofthe work space 1600(WS).

In some cases, the sensors 119 may not observe an entire space due to a low range of the sensor 119, such as a low range LIDAR, or due to limited FOV, such as limited FOV of a solid state sensor 119 or cameras 120, 121. The amount of space observed by a sensor 119, such as a cameras 120, 121, of the autonomous humanoid robot 100 may also be limited in point to point movement. The amount of space observed by the sensor 119 in coverage applications is greater as the sensors 119 collect data as the autonomous humanoid robot 100 drives back and forth throughout the space. In an example areas observed by a processor 1001 of the autonomous humanoid robot 100 with a covered cameras 120, 121 of the autonomous humanoid robot 100 at different time points do not include a backside of the autonomous humanoid robot 100 and the FOV does not extend to a distance. However, once the processor 1001 recognizes new sensor 119 data that corresponds with an area that has been previously observed, the processor 1001 may integrate the newly collected sensor 119 readings with the previously collected sensor 119 readings at overlapping points to maintain the integrity of the map.

In some embodiments, the processor 1001 integrates two consecutive sensor 119 readings. In some embodiments, the processor 1001 sets soft constraints on the position of the autonomous humanoid robot 100 in relation to the sensed data. As the autonomous humanoid robot 100 moves, the processor 1001 adds motion data and sensor 119 measurement data. In some embodiments, the processor 1001 approximates the constraints using maximum likelihood to obtain relatively good estimates. In some embodiments, the processor 1001 applies the constraints to depth readings at any angular resolution or subset of the environment, such a feature detected in an image. In some embodiments, a function comprises the sum of all constraints accumulated to the moment and the processor 1001 approximates the maximum likelihood of the autonomous humanoid robot 100 path and map by minimizing the function. In cases wherein depth data is used, there are more constraints and data to handle. Depth readings taken at higher angular resolution result in a higher density of data.

In some embodiments, the processor 1001 stitches images of the environment at overlapping points to obtain a map of the environment. In some embodiments, the processor 1001 uses least square method in determining overlap between image data. In some embodiments, the processor 1001 uses more than one method in determining overlap of image data and stitching of the image data. This may be particularly useful for three-dimensional scenarios. In some embodiments, the methods are organized in a neural network and operate in parallel to achieve improved stitching of image data.

In some embodiments, the autonomous humanoid robot 100 captures a video of the environment while navigating around the environment. This may be at a same time of constructing the map of the environment. In embodiments, the cameras 120, 121 used to capture the video may be a different or a same cameras 120, 121 as the one used for SLAM.

In some embodiments, the processor 1001 of the autonomous humanoid robot 100 may perform segmentation wherein an object 116 or an obstacle captured in an image is separated from other object 116 and the background of the image. In some embodiments, the processor 1001 may alter the level of lighting to adjust the contrast threshold between the object 116 and remaining object 116 and the background. For example, in an image including an object 116 or an obstacle and a background including walls and floor, the processor 1001 of the autonomous humanoid robot 100 may isolate the object 116 from the background of the image and perform further processing of the object 116. In some embodiments, the object 116 separated from the remaining object 116 and background of the image may include imperfections when portions of the object 116 are not easily separated from the remaining object 116 and background of the image. In some embodiments, the processor 1001 may repair the imperfection based on a repair that most probably achieves the true of the particular object 116 or by using other images of the object 116 captured by the same or a second image sensor 119 or captured by the same or the second image sensor 119 from a different location. In some embodiments, the processor 1001 identifies characteristics and features of the extracted object 116. In some embodiments, the processor 1001 identifies the object 116 based on the characteristics and features of the object 116. Characteristics of the object 116, for example, may include shape, color, size, presence of a leaf, and positioning of the leaf. Each characteristic may provide a different level of helpfulness in identifying the object 116. For instance, the processor 1001 of the autonomous humanoid robot 100 may determine the shape of the object 116 is round, however, in the realm of foods, for example, this characteristic only narrows down the possible choices as there are multiple round foods (e.g., apple, orange, kiwi, etc.). For example, the object 116 may be narrowed down based on shape. The list may further be narrowed by another characteristic such as the size or color or another characteristic of the object 116.

In some cases, the object 116 may remain unclassified or may be classified improperly despite having more than one image sensor 119 for capturing more than one image of the object 116 from different perspectives. In such cases, the processor 1001 may classify the object 116 at a later time, after the autonomous humanoid robot 100 moves to a second position and captures other images of the object 116 from another position. If the processor 1001 of the autonomous humanoid robot 100 is not able to extract and classify ab object 116, the autonomous humanoid robot 100 may move to a second position and capture one or more images from the second position. In some cases, the image from the second position may be better for extraction and classification, while in other cases, the image from the second position may be worse. In the latter case, the autonomous humanoid robot 100 may capture images from a third position. In embodiments, object 116 appear differently from different perspectives.

In some embodiments, the processor 1001 chooses to classify an object 116 or an obstacle or chooses to wait and keep the object 116 unclassified based on the consequences defined for a wrong classification. For instance, the processor 1001 of the autonomous humanoid robot 100 may be more conservative in classifying object 116 when a wrong classification results in an assigned punishment, such as a negative reward, or the processor 1001 of the autonomous humanoid robot 100 may initially be trained in classification of object 116 based on a collection of past experiences of at least one autonomous humanoid robot 100, but preferably, a large number of autonomous humanoid robots 100. In some embodiments, the processor 1001 of the autonomous humanoid robot 100 may further be trained in classification of object(s) 116 based on the experiences of the autonomous humanoid robot 100 itself while operating within a particular dwelling. In some embodiments, the processor 1001 adjusts the weight given to classification based on the collection of past experiences of the autonomous humanoid robot 100 and classification based on the experiences of the respective autonomous humanoid robot 100 itself. In some embodiments, the weight is preconfigured. In some embodiments, the weight is adjusted by a user using an application of a communication device paired with the autonomous humanoid robot 100. In some embodiments, the processor 1001 of the autonomous humanoid robot 100 is trained in object 116 classification using user feedback. In some embodiments, the user may review object 116 classifications of the processor 1001 using the application of the communication device and confirm the classification as correct or reclassify an object 116 or an obstacle misclassified by the processor 1001. In such a manner, the processor 1001 may be trained in object 116 classification using reinforcement training.

In some embodiments, the processor 1001 may determine a generalization of an object 116 or an obstacle based on its characteristics and features or the processor 1001 may localize an object 116 or an obstacle. The object 116 localization may comprise a location of the object 116 falling within a FOV of an image sensor 119 and observed by the image sensor 119 (or depth sensor 119 or other type of sensor 119) in a local or global map frame of reference. In some embodiments, the processor 1001 locally localizes the object 116 with respect to a position of the autonomous humanoid robot 100. In local object 116 localization, the processor 1001 determines a distance or geometrical position of the object 116 in relation to the autonomous humanoid robot 100. In some embodiments, the processor 1001 globally localizes the object 116 with respect to the frame of reference of the environment. Localizing the object 116 globally with respect to the frame of reference of the environment is important when, for example, the object 116 is to be avoided. For instance, a user may add a boundary around a flower pot in a map of the environment using an application of a communication device paired with the autonomous humanoid robot 100. While the boundary is discovered by the local frame of reference with respect to the position of the autonomous humanoid robot 100, the boundary must also be localized globally with respect to the frame of reference of the environment 1600.

In embodiments, the object 116 may be classified or unclassified and may be identified or unidentified. In some embodiments, an object 116 or an obstacle is identified when the processor 1001 identifies the object 116 in an image of a stream of images (or video) captured by an image sensor 119 of the autonomous humanoid robot 100. In some embodiments, upon identifying the object 116 the processor 1001 has not yet determined a distance of the object 116, a classification of the object 116, or distinguished the object 116 in any way.

While magnitude matching serves well for extracting some characteristics, at a lower computational cost the phase may need to be preserved and used to create a better matching system. For instance, for applications such as reconstruction of the perimeters of a map, magnitude-matching may be inadequate. In such cases, the processor 1001 performs normalization for scale, start point shift, and rotation of the Fourier descriptors G.sub.1 and G.sub.2. In some embodiments, the processor 1001 determines the L.sub.2 norm of the magnitude difference vector using dist M .function. (G 1, G 2)=(G1−G 2).function. [m=−M p M p.times. .times. (G 1.function. (m)−G 2.function. (m)) 2]1 2, ##EQU00011 ##however, in this case there are complex values. Therefore, the L.sub.2 norm is a complex-valued difference between G.sub.1-G.sub.2 where m.noteq.0.

In some embodiments, reflection profiles may also be used for acoustic sensing. Sound creates a wide cone of reflection that may be used in detecting obstacles for added safety. For instance, the sound created by a commercial cleaning autonomous humanoid robot 100. Acoustic signals reflected off of different object 116 and object 116 in areas with varying geometric arrangements are different from one another. In some embodiments, the sound wave profile may be changed such that the observed reflections of the different profiles may further assist in detecting an obstacle or area of the environment. For example, a pulsed sound wave reflected off of a particular geometric arrangement of an area has a different reflection profile than a continuous sound wave reflected off of the particular geometric arrangement. In embodiments, the wavelength, shape, strength, and time of pulse of the sound wave may each create a different reflection profile. These allow further visibility immediately in front of the autonomous humanoid robot 100 for safety purposes.

In some embodiments, some data, such as environmental properties or object 116 properties, may be labelled or some parts of a data set may be labelled. In some embodiments, only a portion of data, or no data, may be labelled as not all users may allow labelling of their private spaces. In some embodiments, only a portion of data, or no data, may be labelled as users may not allow labelling of particular or all object 116. In some embodiments, consent may be obtained from the user to label different properties of the environment or of object 116 or the user may provide different privacy settings using an application of a communication device. In some embodiments, labelling may be a slow process in comparison to data collection as it manual, often resulting in a collection of data waiting to be labelled. However, this does not pose an issue. Based on the chain law of probability, the processor 1001 may determine the probability of a vector x occurring using p(x)=.PI..sub.i-1.sup.np(x.sub.ilx.sub.1, . . . , x.sub.i-1). In some embodiments, the processor 1001 may solve the unsupervised task of modeling p(x) by splitting it into n supervised problems. Similarly, the processor 1001 may solve the supervised learning problem of p(y|x) using unsupervised methods. The processor 1001 may learn the joint distribution and obtain p .function. (y x)=p function. (x, y) SIGMA. y′.times. p .function. (x, y′). ##EQU00012 ##.

In some embodiments, the processor 1001 may approximate a function f*. In some embodiments, a classifier y=f*(x) may map an image array x to a category y (e.g., cat, human, refrigerator, or other object 116), wherein x.di-elect cons.{set of images} and y.di-elect cons.{set of object 116}. In some embodiments, the processor 1001 may determine a mapping function y=f(x; .theta.), wherein .theta. may be the value of parameters that return a best approximation. In some cases, an accurate approximation requires several stages. For instance, f(x)=f(f(x)) is a chain of two functions, wherein the result of one function is the input into the other. Given two or more functions, the rules of calculus apply, wherein if f(x)=h(g(x)), the f′ .function. (x )=h′ .function. (g .function. (x)) .times. g′ .function. (x) .times. .times. and .times. .times. dy dx=dy du .times. du dx. ##EQU00013 ##.

In some embodiments, different object 116 within an environment may be associated with a location within a floor plan of the environment. For example, the user may use their mobile phone to manually capture a video or images of the entire house, or the mobile phone may be placed on the autonomous humanoid robot 100 and the autonomous humanoid robot 100 may navigate around the entire house while images or video are captured. The processor 1001 may obtain the images and extract a floor plan of the house.

In some embodiments, dynamic obstacles, such as people or pets, or obstacles may be added to the map by the processor 1001 of the autonomous humanoid robot 100 or a user using the application of the communication device paired with the autonomous humanoid robot 100. In some embodiments, dynamic obstacle may have a half-life, wherein a probability of their presence at particular locations within the floor plan reduces over time. In some embodiments, the probability of a presence of all obstacles and walls sensed at particular locations within the floor plan reduces over time unless their existence at the particular locations is fortified or reinforced with newer observations.

In some embodiments, the processor 1001 of the autonomous humanoid robot 100 tracks object 116 that are moving within the scene while the autonomous humanoid robot 100 itself is moving. Moving object 116 may be SLAM capable (e.g., other autonomous humanoid robots 100 or service robots and the like), or SLAM incapable (e.g., humans and pets). the processor of the autonomous humanoid robot generates architectural plans based on SLAM data, for instance, in addition to the map the processor to locate doors and windows and other architectural elements; the processor uses the SLAM data to add accurate measurement to a generated architectural plan, in which a portion of this process can execute automatically using, for example, a software that may receive main dimensions of object 116 and/or architectural icons (e.g., rooms, stairs, paths, streets, etc.) corresponding to the space as input.

In some embodiments, the processor 1001 may be interested in more than just the presence of the object 116. For example, the processor 1001 of the autonomous humanoid robot 100 may be interested in understanding a hand gesture, such as an instruction to stop or navigate to a certain place given by a hand gesture such as finger pointing. Or the processor 1001 may be interested in understanding sign language for the purpose of translating to audio in a particular language or to another signed language.

In embodiments, SLAM technologies described herein (e.g., object 116 tracking) may be used in combination with AR technologies, such as visually presenting a label in text form to a user by superimposing the label on the corresponding real-world object 116. Superimposition may be on a projector, a transparent glass, a transparent LCD, etc.

In embodiments, SLAM technologies may be used to allow the label to follow the object 116 in real time as the autonomous humanoid robot 100 moves within the environment and the location of the object 116 relative to the autonomous humanoid robot 100 changes.

In some embodiments, a map of the environment is separately built from the obstacle map. In some embodiments, an obstacle map is divided into two categories, moving and stationary obstacle maps. In some embodiments, the processor 1001 separately builds and maintains each type of obstacle map. In some embodiments, the processor 1001 of the autonomous humanoid robot 100 may detect an obstacle based on an increase in electrical current drawn by a wheel or brush or other component motor. For example, when stuck on an object 116 or an obstacle, the brush motor may draw more current as it experiences resistance cause by impact against the object 116. In some embodiments, the processor 1001 superimposes the obstacle maps with moving and stationary obstacles to form a complete perception of the environment.

In some embodiments, it may be helpful to introduce the processor 1001 of the autonomous humanoid robot 100 to some of the moving object 116 the autonomous humanoid robot 100 is likely to encounter within the environment.

For example, if the autonomous humanoid robot 100 operated within a house, it may be helpful to introduce the processor 1001 of the autonomous humanoid robot 100 to the humans and pets occupying the house by capturing images of them using a mobile device or a cameras 120, 121 of the autonomous humanoid robot 100. It may be beneficial to capture multiple images or a video stream (i.e., a stream of images) from different angles to improve detection of the humans and pets by the processor 1001. For example, the autonomous humanoid robot 100 may drive around a person while capturing images from various angles using its cameras 120, 121. In another example, a user may capture a video stream while walking around the person using their smartphone. The video stream may be obtained by the processor 1001 via an application of the smartphone paired with the autonomous humanoid robot 100. The processor 1001 of the autonomous humanoid robot 100 may extract dimensions and features of the humans and pets such that when the extracted features are present in an image captured in a later work session, the processor 1001 may interpret the presence of these features as moving object 116.

As the processor 1001 makes use of various information, such as optical flow, entropy pattern of pixels as a result of motion, feature extractors, RGB, depth information, etc., the processor 1001 may resolve the uncertainty of association between the coordinate frame of reference of the sensor 119 and the frame of reference of the environment. In some embodiments, the processor 1001 uses a neural network to resolve the incoming information into distances or adjudicates possible sets of distances based on probabilities of the different possibilities. Concurrently, as the neural network processes data at a higher level, data is classified into more human understandable information, such as an object 116 or an obstacle name (e.g., human name or object 116 type such as remote), feelings and emotions, gestures, commands, words, etc. However, all the information may not be required at once for decision making. For example, the processor 1001 may only need to extract data structures that are useful in keeping the autonomous humanoid robot 100 from bumping into a person and may not need to extract the data structures that indicate the person is hungry or angry at that particular moment. Additionally, the autonomous humanoid robot 100 may interact with other devices, such as service robots like drones, and vehicles in real-time.

In some embodiments, the autonomous humanoid robot 100 becomes stuck during operation due to entanglement with an object 116 or an obstacle. The autonomous humanoid robot 100 may escape the entanglement but with a struggle. For example, an autonomous humanoid robot 100 may become entangled with the U-shaped base during operation. In some embodiments, the processor 1001 calculates a size of an object 116 or an obstacle with which the autonomous humanoid robot 100 has become entangled with and/or struggled to navigate around for a current and future work sessions. For example, if the autonomous humanoid robot 100 becomes stuck on the object 116 again after calculating its size a first time, the processor 1001 may inflate the size more as needed. Some embodiments include a process for preventing the autonomous humanoid robot 100 from becoming entangled with an object 116 or an obstacle. At a first step, the processor 1001 determines if the autonomous humanoid robot 100 becomes stuck or struggles with navigation around an object 116 or an obstacle. In some embodiments, the autonomous humanoid robot 100 may navigate around only a particular portion of an object 116 or an obstacle.

The computing system 1000, executed by the processor 1001 of the autonomous humanoid robot 100 deems a session complete and transitions the autonomous humanoid robot 100 to a state that actuates the autonomous humanoid robot 100 to find a charging station; the autonomous humanoid robot 100 navigates to the charging station to empty a bin of the autonomous humanoid robot 100 after a predetermined amount of area is covered by the autonomous humanoid robot 100 or when the session is deemed complete; and the map is stored in a memory accessible to the processor 1001 of the autonomous humanoid robot 100 during a subsequent operational session of the autonomous humanoid robot 100.

The autonomous humanoid robot 100 executes at least one action in at least one of a current work session and a future work session based on the images captured.

The autonomous humanoid robot 100 further comprising: extracting, by the processor 1001 of the autonomous humanoid robot 100, characteristics data from the images comprising any of an edge characteristic, a basic shape characteristic, a size characteristic, a color characteristic, and pixel densities.

The autonomous humanoid robot 100 further configured for identifying the class to which the at least one object 116 belongs is probabilistic and uses a network of connected computational nodes organized in at least three logical layers and processing units to determine any of perception of the work space 1600(WS), internal and external sensing, localization, mapping, path planning, and actuation of the autonomous humanoid robot 100.

The autonomous humanoid robot 100, wherein at least one action of the autonomous humanoid robot 100 in response to identifying the class to which the at least one object 116 belongs comprises at least one of executing an altered navigation path to avoid driving over the object 116 identified and maneuvering around the object 116 identified and continuing along the planned navigation path.

In various aspects the computing system 1000 associated user interface 1100 as a teaching image for learning with interactive user interface 1100 having face recognition 1200 and voice recognition 1300 and autonomous humanoid robot interface 1400 all linked with the control panel 114. The computing system 1000 associated with interfacing with the autonomous humanoid robot at least one camera configured to capture live images of the autonomous humanoid robot 100; the at least one camera performs processing for predicting image data based on the teaching image model; of a computing system 1000; the current image of the situation captured by the at least one camera 121, 120 during the aforementioned adjustment operation is constructed identifying a user gesture captured by said inputs; and determining a meaning of a user speech captured at least one of contemporaneously and in close time proximity of said user speaking gestures. Appropriately, the user interface associated with social interact providing an interaction desire and personality functions to identify a desire or need for interaction between the autonomous humanoid robot 100 and the user's environment external to the autonomous humanoid robot 100 operating environment. Interactions between the autonomous humanoid robot 100 and the external environment preferably include interactions between persons or other entities (e.g., users, vehicles or nature) and may additionally or alternatively include interactions with the autonomous humanoid robot 100 and any aspect of social environments (e.g., what is happening in the moment around the autonomous humanoid robot 100).

The autonomous mode associated with a GPS that detects a moving direction of the mobile unit using GPS and outputs a GPS direction signal; the GPS direction signal output from the GPS receiver, the magnetic azimuth signal output from the magnetic azimuth sensor and calculating a rolling angle, pitch angle and azimuth, wherein said calculation unit comprises an attitude/azimuth calculation section that calculates a rolling angle, pitch angle and azimuth from said coordinate transformation matrix compensated by the level error compensatory value and azimuth error compensatory value, and said calculation section for azimuth error compensatory value which, when a reliability of the GPS direction signal is high, calculates the azimuth error compensatory value using the GPS direction signal and, calculates a difference between the GPS direction signal and the magnetic azimuth signal and which, when the reliability of the GPS direction signal is not high and when a reliability of the magnetic azimuth signal is high, calculates the azimuth error compensatory value by using the magnetic azimuth signal and using said difference between the GPS direction signal and the magnetic azimuth signal calculated when the reliability of the GPS direction signal is high.

Some embodiments may provide a real time navigational stack configured to provide a variety of functions. The collection of the advantages of the real time navigational stack consequently improve performance and reduce costs, thereby paving the road forward for mass adoption of humanoid robots within homes, offices, small warehouses, and commercial spaces. In embodiments, the real time navigational stack may be used with various different types of systems, such as Real Time Operating System (RTOS), Robot Operating System (ROS), and Linux.

The real time navigational stack may reduce computational burden, and consequently may free the hardware for functions such as object 116 recognition, face recognition, voice recognition, and other AI applications of a humanoid robot 100. Additionally, the boot up time of the humanoid robot 100 using the real time navigational stack may be faster than prior art methods. In general, the real time navigational stack may allow more tasks 1060 and features while reducing battery consumption and environmental impact.

The term “Memory Narratives” refers to time-series basis coordinates (TSBCs)=basis coordinates with an additional temporal component.

The term “Hierarchical Time Basis Coordinates (HTBSCs)” refers to TSBCs converted to a hierarchical representation by a ROS excitatory/inhibitory network.

The term “Spiking Neural Network (SNN) refers to a connected network of simulated neurons in which the neurons have a mathematical model which simulates combining the inputs from its dendritic (input) connections, doing a computation based on them, and when computed, to emit spikes of current onto the SNN's axonal output, which then branch and connect to other neuron's dendrites via simulated synapses. The defining characteristic of a SNN is that the spikes of current move along the axons and dendrites in time, giving it spatial-temporal computing capabilities.

The terms “training”, “learning”, and “unsupervised learning” all refer to unsupervised learning accomplished by the neural net automatically strengthening and weakening synaptic connections by an internal process similar to the biological Hebbian principle, by strengthening synapses when both of the neurons they connect fire within an interval specified in the genome by the user.

The term “Basis Coordinates” refers to the output of convolving an input engram with the leaf-node engrams in the engram basis set.

After a predetermined duration (as specified by a variable set by the user in the initial design and subsequent genetic algorithm modifications) of short-term memory has been recorded, it is batch processed by cutting it into segments by convolving it with a time-domain function like a Gaussian or unit step function centered at time t and advancing t by dt each time such that the segments have a predetermined overlap.

For the purposes of the example embodiment of FIG. 10, various functions are shown to be performed on different programmable computing devices that communicate with each other over the Internet. These computing devices may include smartphones, laptop computers, tablets, and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present technology. The attached claims recite any required combination of functionality onto a single machine, if required, and all example embodiments are for descriptive purposes.

The terms “subject” and “user” refer to an entity, e.g. a human, using a system and method for providing artificial intelligence using neural networks and other computer hardware and software devices and methods to simulate human intelligence according to the present technology including any software or smart device application(s) associated with the technology. The term user 1101, herein refers to one or more users.

The terms “training”, “learning”, and “unsupervised learning” all refer to unsupervised learning accomplished by the neural net automatically strengthening and weakening synaptic connections by an internal process similar to the biological Hebbian principle, by strengthening synapses when both of the neurons they connect fire within an interval specified in the genome by the user 1101.

In general, the present disclosure relates to a system and method for providing artificial intelligence processing, and more specifically, to a system and method for providing artificial intelligence using neural networks and other computer hardware and software devices and methods to simulate human intelligence. To better understand embodiments of the present technology.

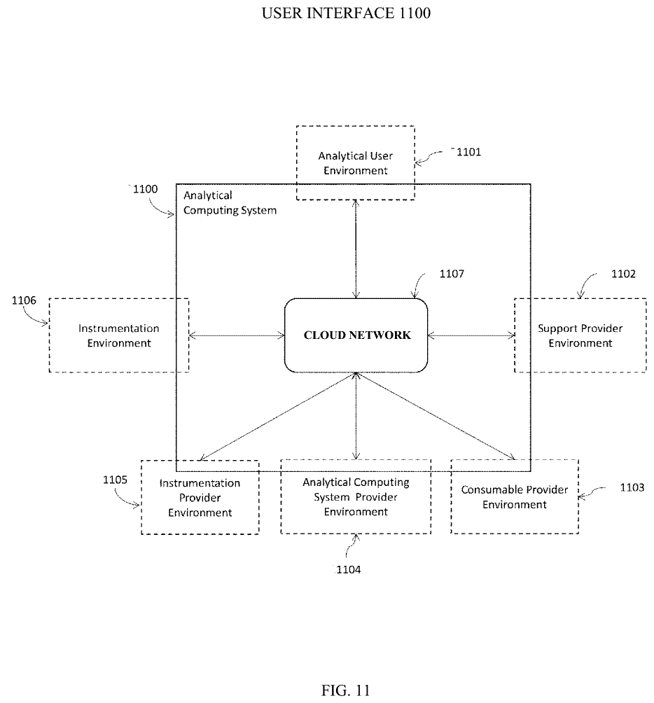

In greater detail, FIG. 11 is a flowchart respective of a user interface analytical computing sy stem 1100 (UIACS) provided for a user 1101 to communicate and interact with the autonomous humanoid robot interface system 1400. The user 1101 can readily interact with an autonomous humanoid robot 100 during working events through a control panel disposed on a front portion the body 101, the control panel 114 which is directly linked to the head 102. The user 1101 can readily interact with an autonomous humanoid robot 100 during working events through smart I/O devices which may include one or more of the following: a smartphone, display touchscreens and other smart I/O devices; (e.g., iPhone, iPad), wearable devices (e.g., iWatch), laptops, VR headset. The control panel to cooperate, coordinate and/or interact with other systems, subsystems, or components that are logically or physically connected thereto, including remote or metro networks 1103. Searching by using information about a person selected from a person list extracted from the video database 1104 and the touch screen display. Controlling display of at least one of the extracted frame-based thumbnail 1105, appearance video ID, person ID, and person appearance section information, engaging the virtual touch screen of the control panel 114.

According to the method, the user of the autonomous humanoid robot, in an owner-defined manner by user recognition 1101, is allowed a administer operation interface tag to enter operation instructions; a non-administrator user 1101 or person is allowed a limited operation interface tag; the owner can edit the non-administrator interface 1102 so that the display content is effectively controlled, the personal privacy of the owner of the autonomous humanoid robot is better protected, the non-administrator user is allowed to enter limited operation instructions 1016. The user 1101 can readily interact with an autonomous humanoid robot 100 during working events through a control panel disposed on a front portion the body 101, the control panel 114 which is directly linked to the head 102. The user 1101 can readily interact with an autonomous humanoid robot 100 during working events through smart I/O devices which may include one or more of the following: a smartphone, display touchscreens and other smart I/O devices; (e.g., iPhone, iPad), wearable devices (e.g., iWatch), laptops, VR headset. The control panel to cooperate, coordinate and/or interact with other systems, subsystems, or components that are logically or physically connected thereto, including remote or metro networks. Searching by using information about a person selected from a person list extracted from the video database and the touch screen display. Controlling display of at least one of the extracted frame-based thumbnail, appearance video ID, person ID, and person appearance section information, engaging the touch screen.

In one or more application events the computing system 102 comprising processors, memory, algorithms, RTOS, and a maneuver execution mechanism consisting of programming software connected and communicated with the control unit through Bluetooth or Wi-Fi, and the smart device providing software updating capability. The user interface may engage the semiautonomous mode linking to an external computer system provided by one or more controller devices, not shown, respective of a wireless controller means for controlling of manipulators 107a-107c.

Accordingly, the method for identifying user interface 1100 of a user 1101 an interaction desire preferably includes at least one of detecting an external interaction request and generating an internal interaction request. External interaction requests are preferably detected when a person or entity external to the autonomous humanoid robot 100 expresses (e.g., through an input mechanism, by moving near the autonomous humanoid robot 100) an explicit or implicit desire to interact with the autonomous humanoid robot 100. Internal interaction requests are preferably generated when the autonomous humanoid robot 100 decides that interaction with the external environment is desirable despite not detecting a desire for interaction from another entity; for example, the autonomous humanoid robot 100 may generate an internal interaction request 1103f or learning current events (or communications links receive news reports) near the autonomous humanoid robot 100.

As FIG. 11 shows a cloud-based system providing seamless integration of other systems, computers, and instruments, e.g. bio-instruments, supporting and optimizing users doing analytical work. e.g. bioanalytical work, 1100 is the system boundary around the other systems, computers, and instruments either wholly or partly makes up the UIACS 1100, wherein, the operating system on each computer and/or instrument, in whole or part, includes the UIACS 1100 can include, e.g., Window™, UNIX. Linux, MacOS™, iOS™, Android™, and/or any other commercial, open-source, and/or special-purpose operating system. At 1101 is an analytical user environment including one or more servers, desktop computers, laptop computers, tablet, and/or mobile devices of which one or more of same can be used in UIACS 1100. One or more analytical user 1101 can use the analytical system 1100. At 1102 is a support provider environment including one or more servers, desktop computers, laptop computers, tablet, and/or mobile devices of which one or more of same can be used in UIACS 1100 supporting instruments, consumables, and/or software used by analytical users in analytical user environment 1101. There can be one or more support provider environments using the UIACS 1100. At 1103 is a consumable provider environment including one or more servers, desktop computers, laptop computers, tablet, and/or mobile devices of which one or more of same can be used in UIACS 1100 for providing consumables to be used by users in analytical autonomous humanoid robot environment 1600, optionally in conjunction with instrumentation including instrumentation environment 1106 within cloud networks 1107. There can be one or more consumable provider environments at 1103 using the UIACS 1100.

At 1105 is an analytical instrumentation provider environment for a provider of instrumentation that can be used in instrumentation environment and that includes one or more servers, desktop computers, laptop computers, tablet, and/or mobile devices of which one or more of same can be used in UIACS 1100 for providing, e.g., selling or otherwise transferring instruments to be used by users in analytical user environment. There can be one or more instrumentation provider environments 1600 using the UIACS 1100. At 1104 is an UIACS provider environment for the provider of UIACS 1100, which includes one or more servers, desktop computers, laptop computers, tablet, and/or mobile devices of which one or more same can be used in computing system 1000 to manage the business interaction with UIACS 1100 to be used by analytical users in analytical user environment 1600. Each of the “providers” associated with the environments 1600 can include one or more entities, including without limitation, a multiplicity of independent businesses, a single independent business, a combination of different independent businesses, or one or more businesses within any one of the “providers” herein. At 1106 is an instrumentation environment including one or more instruments, each with at least one computer that in one practice can be at least partially used by UIACS 1100 to run tests on samples for users in an analytical user environment 1101. At 1107 is a cloud platform leveraged to connect, e.g., bi-directionally connect, through computers, networking, and software some or all of the computers in UIACS 1100 having in one practice, a common computing, software services, and data architecture such that data can be collected and shared by any computer having associated software of the UIACS 1100, wherever a particular computer with associated software in UIACS 1100 is located throughout the world, in a secure manner, wherein cloud platform 1107, in the preferred embodiment, is hosted by a public-cloud provider providing a shared computing environment, for example, Amazon™ Web Services, Google™ Cloud, Microsoft™ Azure, or others. In other embodiments, the cloud platform 1107 can be hosted by the UIACS provider at 1104, or it can be self-hosted by an analytical user environment being a user of the UIACS 1100; or it can be hosted by a private-cloud provider providing a dedicated computing environment, for example, Oracle™ Cloud, IBM™ Cloud, Rackspace, or others; or it can be hosted on some combination of public-cloud, private-cloud, self-hosted, and hosted by the UIACS provider 1104. All communication with cloud platform 1107 can be done through the preferred embodiment over a secure communication protocol, such as without limitation https, to encrypt all communication between sender and receiver; but an unsecure communication protocol, such as without limitation Hypertext Transfer Protocol Secure (HTTPS), can be used as well using optionally in either the secured or unsecured case connected technologies, such as Ethernet for local area network (LAN), metropolitan area network (MAN), and/or wide area network (WAN) configurations, and/or unconnected technologies, such as WIFI, Bluetooth. and/or other like technologies for a distributed LAN. Additionally, UIACS 1100 can be wholly deployed on one computer such that all operations of UIACS 1100 occur on that computer with the only external communication occurring between computers and associated software running outside of UIACS 1100.

As exampled, FIG. 11 is a diagram respective of user interface UIACS 1100 providing common computing, software services, and data architecture such that data are collected and shared by any computer anywhere in the world having associated software of the UIACS 1100, wherein, one or more services servers provide a scalable, robust, and high-accomplishing computing and associated software platform to support services specific to the UIACS 1100 for retrieving, storing, transferring, and/or transforming data associated with the use of the UIACS 1100; one or more database servers (e.g., including one or more team databases and one or more system databases) providing a scalable, robust, and high-accomplishing computing and associated software platform for one or more structured databases used for storing and/or retrieving data produced by and/or for users of the UIACS 1100, as well as, for storing and/or retrieving data produced and/or used by the UIACS 1100 for its preparation for use as well as through its use, wherein, the database technology can be relational in nature as e.g. SQL Server, Oracle, MySQL, Postgres, Aurora, and/or other like relational database technologies; and/or can be non-relational in nature as e.g. Dynamo DB, Mongo DB, and/or other like non-relational database technologies; with one or more bulk data servers, which may include system content, instrument content and consumable content, providing a scalable, robust, and high-accomplishing computing and associated software platform for storing and retrieving file-based data provided for use of the UIACS 1100 and/or produced through the use of the UIACS 1100. The services server(s) has associated with it, in one embodiment, a logical collection of services, namely: admin including a logical collection of services to support administration of the use of UIACS 1100; dashboard including a logical collection of services to support monitoring and control of the use of UIACS 1100; upload including a logical collection of services supporting upload of consumable and instrument information to UIACS 1100; system including a logical collection of services supporting various non-user-specific functions associated with overall use of UIACS; application including a logical collection of services supporting typical scientific use of UIACS by users; and authenticate including a logical collection of services supporting secure log-in to UIACS 21100 as well as log-out from UIACS 1100.

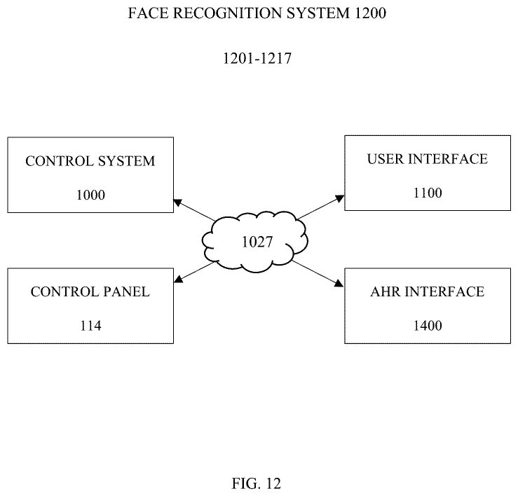

In greater detail, FIG. 12 is a flowchart respective of a face recognition system 1200, in various aspects the computing system 1000 associated with the face recognition 1200 having a face recognition module 1201 to determine recognition of face patterns 1209 of a user 1101, the facial recognition module 1201 includes a camera input 1202, a video database 1203 including a video information 1204. Accordingly, the face recognition module 1201 linked with peripheral equipment through a Wi-Fi wireless network or by Bluetooth is transmitted to a microprocessors 1014 of said autonomous humanoid robot 100 to perform spontaneous and predefined logic. The facial recognition module 1201 comprising processors 1013 and a computer readable storage medium 1206 storing a cluster subject 1207 extracted based on a face feature input 1208, and video information 1204 detection using the video database 1203 conducts recognition of the face feature input 1208 of one or more users 1101.

According to the present invention, skeleton analysis and face recognition are possible using artificial intelligence (AI model 1209) of deep learning through a 4G, 5G network, and face feature input 1208 is constructed at the edge stage by using an analysis result of the AI model 1209. In one element the artificial intelligence AI model 1209 provides a control instruction 1210 for the user 1101 to enter his or her identification tag input 1211 on the control panel 120 disposed on the body 101 to identify the user via a face recognition module 1201, thus dentification is carried out, a control instruction 1210 for the user 1101 to enter his or her identification tag input 1211 on the control panel 120, thus a control instruction 1210 according to identification result 1212 is carried out. The face recognition module 1201 generating a control instruction 1208 according to identification result 1212, shows corresponding control operations 1213 to thus interface via the facial recognition module 1201, wherein the control instruction 1210 is called according to the tag input 1211 is shown in the control panel 120. Wherein the facial recognition module 1201 updates image data.

Updating an image data of the face feature input 1208 base 1214 to include moving image information 1215 of an extracted cluster subject 1216 based on the clustering using facial features 1217 and accomplishing a search by using a face feature of the person extracted from the face image input as the search condition and using information about the person selected from the person list extracted from the video database.

In greater detail the Face Recognition System 1200, in various aspects the computing system 1000 is associated with the voice recognition system 1200, wherein the face recognition module 1201 is connected with the computing system 1000 and used for carrying out face recognition of a user 1101 when interfacing with the autonomous humanoid robot; the face recognition module 1201 sending a face recognition result to the computing system; and the computing system is connected with the operation screen of the control panel 114 and used for carrying out identity recognition of the user of the autonomous humanoid robot 100 according to the face recognition result and generating a control instruction according to the identity recognition result so as to control the operation of a control panel to display a corresponding operation instruction of the user 1101 who may be the owner of the autonomous humanoid robot.

The face recognition module 1201 to determine recognition of face patterns 1209 of a user 1101 behavior recognition module the facial recognition module 1201 includes a camera input 1202, a video database 1203 including a video information 1204. Accordingly, the face recognition module 1201 is linked with peripheral equipment through a Wi-Fi wireless network or by Bluetooth is transmitted to a microcontroller of said autonomous humanoid robot 100 to perform spontaneous and predefined logic. The facial recognition module 1201 comprising processors 1205 and a computer readable storage medium 1206 storing a cluster subject 1207 extracted based on a face feature input 1208, and video information 1204 detection using the video database 1203 conducts recognition of the face feature input 1208 of one or more users 1200.

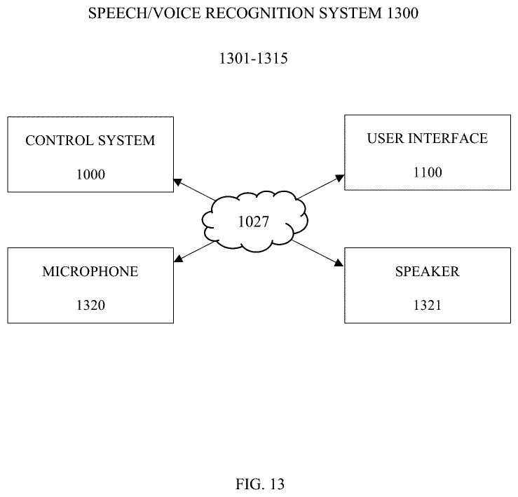

In greater detail FIG. 13 illustrates a Voice Recognition System 1300. In various aspects the computing system 1000 associated with speech and voice recognition system 1300 having a speech and voice recognition module 1301 to determine recognition of speech patterns 1309 of a user 1101, the speech and voice recognition module 1301 includes a camera input 1202, a video database 1203 including a video information 1204. Accordingly, the speech/voice recognition module 1301 linked with peripheral equipment through a Wi-Fi wireless network or by Bluetooth is transmitted to microprocessors 1014 of said autonomous humanoid robot 100 to perform spontaneous and predefined logic. The facial recognition module 1201 comprising processors 1013 and a computer readable storage medium 1206 storing a cluster subject 1207 extracted based on a command input 1308, and video information 1204 detection using the video database 1203 conducts speech via voice recognition of the command input 1308 of one or more users 1101.

Accordingly a skeleton analysis and face recognition are possible using artificial intelligence of deep learning through a 4G, 5G network, and speech feature input 1308 is constructed at the edge stage by using an analysis result of the AI model 1001. Updating an image data of the face feature input 1208 base 1214 to include moving image information 1215 of an extracted cluster subject 1216 based on the clustering using facial features 1217. Receiving a search condition for searching for video information 2118 and video database 1219 in which the cluster subject 1216 appears. In various aspects user 1101 interface is associated with the speech and voice recognition 1300 having a speech recognition module 1300 according to an embodiment of the present invention may be performed by a user's keyword command 1305 through a microphone 1320.

The user 1101 can input a voice command 1301 through a microphone 1320 installed in the autonomous humanoid robot 100. At this time, a voice command 1301 can be transmitted to the speech and voice recognition module 1301. The user 1101 can input a voice command; (b) for accomplishing an operation corresponding to a keyword command 1305.

The speech and voice recognition system 1300 according to an embodiment of the present invention includes: receiving a voice command 1305 through a microphone 1320; accomplishing an operation corresponding to a keyword command 1305 when the received voice command corresponds to a pre-stored keyword command 1305. And transmitting the speech/voice data including the voice 1301 command to the voice server 1309 when the received voice command does not correspond to the pre-stored keyword command, thereby enabling voice recognition to be efficiently performed. In particular, there is no need for the user 1101 to operate the remote controller, and the user 1101 convenience can be increased. When the user's voice reaches the speech and voice recognition module 13001, the preprocessing unit 1302 of the speech recognition module 1300 can extract input speech 1304. Here, the speech recognition module 1300 providing a voice recognition algorithm (1303). This step may be performed in the preprocessing unit 1302 of the speech and voice recognition module 1300. At this time, the voice recognition algorithm 1304 may be stored in the preprocessing unit 1302. That is, the preprocessing unit 1302 can receive the feature vector extracted from the preprocessing unit 1302, and the preprocessing unit 1302 can convert the recognition vector into the recognizable text using the stored voice recognition algorithm 1303. Accordingly the voice recognition algorithm 1303 may include an acoustic model 1306, a language model 1307, and a data dictionary 1308, and may be performed in the following three steps.

Accordingly Step 1: The acoustic model 1306 adapts to the user's keyword command 1305, the acoustic model 1306 can be extracted from the preprocessing unit 1302 to derive the speech recognition result. In this case, considering that the phonetic characteristic are different from a microphone 1320, the acoustic model 1306 can be adapted to the speaker 1321. Here, the acoustic model 1306 may use a Maximum Likelihood Linear Regression (MLLR) and a Maximum A Posteriori (MAP) adaptation scheme. After accomplishing MLLR adaptation, MAP (Maximum A Posteriori) adaptation is performed sequentially You can proceed. The user 1101 can input a voice command for accomplishing an operation corresponding to a keyword command 1305 such that the recognition rate can be further increased.

Accordingly Step 2: The keyword command 1305 is recognized by comparing the acoustic model adapted to the speaker 1321, if the initial acoustic model 1306 adapts to the speaker 1321 in step 1, the microphone 1320, at this time, the acoustic model 1306 can perform more accurate recognition through speaker 1321 adaptation.

Accordingly Step 3: The language model 1307 extracts the candidate phonemes or candidate words according to the recognized speech, and then the correct voice is discriminated by using the data dictionary 1308. Then, the recognition result is user command 1310 for control of an autonomous humanoid robot 100 motion control in an operating environment 1001. According to the voice recognized in real time, the language model 1307 can extract candidate phonemes or candidate words through word unit search and sentence unit search through HMM (Hidden Markov Model) technique. Here, the language model 1307 can compare the extracted candidate phonemes or candidate words through a predetermined data dictionary 1308 to determine the most suitable word or phoneme. The recognizable keyword command 1305 derived through the voice recognition algorithm 1304 can be converted into texts that can control the speed and delivered to the programming language 1311. This step can be performed in the speech/voice recognition module 1300. The recognizable keyword command 1305; (e) generating a speed control command through a programming language 1311 of the input speech 1304. The input speech 1304 is transferred to programming language 1311 can generate a speed control command 1312 through a coded algorithm 1313. At this time, the generated speed control command 1312 may be transmitted to the computing system 1000 that controls the autonomous humanoid robot 100 in a wired communication module 1314 or wireless manner such as Wi-fi or Bluetooth. Meanwhile, the programming language 1311 may be provided in C/C++ or Python. Accordingly; (f) the computing system 1000 controls the autonomous humanoid robot 100 according to the keyword command 1305.

Accordingly Step 4: The computing system 1000 performs voice recognition process 1302a via the preprocessing unit 1302, the communication module 1314 transmitting voice data 1315 from the audio input unit provided by microphone 1320 and receiving recognition result data 1316 on the voice data 1315 from the microphone 1320 and the speaker 1321s 1321; the computing system 1000 according to the user's voice 1101(V) can control a maneuver of the autonomous humanoid robot 100 without the need of a remote controller device. According to the computing system 1000, the switching signal to switch the autonomous humanoid robot 100 from the semiautonomous mode 1003 back to the target operation mode; wherein the processor 1013 further: receives a status signal from the at least one sensor; based on the status. The signal determines a state of the autonomous humanoid robot 100 and determines whether the at least one switching signal is generated based on the state of the autonomous humanoid robot 100. According to the computing system 1000, includes the autonomous mode, in which an autonomous humanoid robot interface 1400 determines and executes a navigation strategy substantially-independently without input from a user 1101.

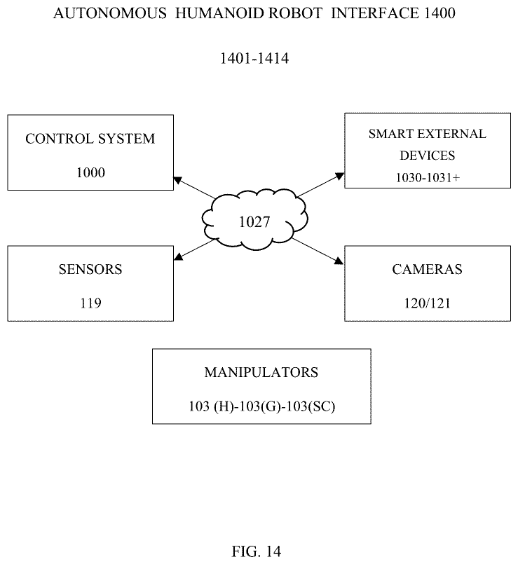

In greater detail, FIG. 14 illustrates a flowchart respective of an autonomous humanoid robot interface system 1400 comprising an object 116 recognition method 1401 executed by computing system 1000 that provides for Artificial General Intelligence (AGI) 1401 configured for generating object 116 detection, the AGI comprising: obtaining point cloud data 1402 related to a surface of an object 116 and to cameras 119, 120, sensors 119 configured to obtain positional information in three dimensions; deriving or obtaining, based on the point cloud data 1402 at a first time in time 1403, first parameters at the first point in time 1404, the first parameters representing a position 1405 and an axial direction 1406 for each of a plurality of parts 1407 of the object 116; and deriving another first parameters at a second point in time after the first point in time, based on another point cloud data 1402 at the second point in time, the first parameters at the first point in time, and one or more geometric models 1408 each having an axis (X,Y, Z) direction 1409, wherein the obtaining of the point cloud data 1402 is executed per cycle 1410, and wherein the second point in time is included in a cycle next to a cycle including the first point in time; wherein the object 116 recognition method deriving of the first parameters at the first point in time includes a fitting process 1411 in which the one or more geometric models 1408 are fit into the point cloud data 1402 at the first point in time at a plurality of locations, to derive the first parameters at the first point in time based on the positions and the axial directions 1409 of the one or more geometric models 1412 fit into the point cloud data 1402 at the first point in time, and wherein the deriving of the other first parameters at the second point in time includes deriving the other first parameters at the second point in time based on the positions and the axial directions 1409 of the one or more geometric models 1412 fit into the other point cloud data 1402 at the second point in time.

The autonomous humanoid robot interface 1400 further comprising: processors, memory and decision-making algorithms to achieve diverse handling tasks 1060 1413 and services in an autonomous humanoid robot's operating environment 1001, a work space 1600(WS), or during game play environments via a man-machine interface maneuver 1414. Respectively an autonomous humanoid robot interface 1400 associated with a coordinate transformation matrix updating section that successively calculates and updates a coordinate transformation matrix from the body 101 to which said one or more gyros and accelerometers are attached; into a local coordinate system using said angular velocity signals; a coordinate transformation section that performs a coordinate transformation of said acceleration signals using the coordinate transformation matrix from said coordinate transformation matrix updating section; a calculation section for level error compensatory value that calculates a level error compensatory value using the acceleration signals transformed by the coordinate transformation section; wherein said computing system 1000 determines to switch from one operating mode function 1050 function 1050 to another operating mode function 1050 function 1050.

AGI 1401 methods and processes for computer simulations are able to operate on general inputs and outputs that do not have to be specifically formatted, nor labelled by humans and can consist of any alpha-numerical data stream, 1D, 2D, and 3D temporal-spatial inputs, and others. The AGI is capable of doing general operations on them that emulate human intelligence, such as interpolation, extrapolation, prediction, planning, estimation, and using guessing and intuition to solve problems with sparse data. These methods will not require specific coding, but rather can be learned unsupervised from the data by the AGI 1401 comprises a processing system 1401(PS) and internal components using spiking neural networks. Using these methods, the AGI 1401 would reduce the external data to an internal format that computers can more easily understand, be able to do math, linear algebra, supercomputing, and use databases, yet still plan, predict, estimate, and dream like a human, then be able to convert the results back to human understandable form.

AGI methods and processes for instructions 1003 are able to operate on general inputs and outputs that do not have to be specifically formatted, nor labelled by humans and can consist of any alpha-numerical data stream, 1D, 2D, and 3D temporal-spatial inputs, and others. The AGI is capable of doing general operations on them that emulate human intelligence, such as interpolation, extrapolation, prediction, planning, estimation, and using guessing and intuition to solve problems with sparse data. These methods will not require specific coding, but rather can be learned unsupervised from the data by the AGI 1401 and its internal components using spiking neural networks. Using these methods, the AGI 1401 would reduce the external data to an internal format that computers can more easily understand, be able to do math, linear algebra, supercomputing, and use databases, yet still plan, predict, estimate, and dream like a human, then be able to convert the results back to human understandable form. All details of these methods will be further elaborated on in the full description of the present technology, and the paragraph numbers of those descriptions noted below.

The AGI 1401 accepts unstructured input data a-n into a spiking neural network encoder for processing into a compact Engram dataset. The input data may consist of unstructured speech and sound data, unstructured vision and image data, and unstructured touch stimulation data among other possible sources of data such as alphanumeric data.

In greater detail FIG. 15 illustrates a smart docking station 1500 configured for charging the autonomous humanoid robot 100 or the smart docking station is portable for transporting the autonomous humanoid robot 100, the smart docking operates during a battery charging mode 1055, and during charging the autonomous humanoid robot can sleep when initiated by a sleep mode 1056, as shown the smart docking station is configured with an upper section 1501, a contoured framed hanger supporting upper body 102, lower body 103, a wheeled base 1504, a charging module 1505(B), a battery charging control system 1506 configured for activating a charging process 1507 and an AC cord 1508 having a hanger means 1509. The autonomous humanoid robot's computing system 1000 is configured for initiating a battery charging mode controlling the autonomous humanoid robot to seek out the smart docking station Wherein the contoured framed hanger 1502 is controlled mechanically for cradling the autonomous humanoid robot 100 via powered torsion hinges 1507. The base 1503 is configured with a motorized wheel array 1504(F), 1504(B) configured with a braking means when the autonomous humanoid robot is transporting or locking means 1505a-d.

Respectively the upper portion 103 of the autonomous humanoid robot containing a charging module 1505(A) provided for charging one or more batteries of an autonomous humanoid robot 100.

As shown, the charging modules 1505(A) and 1505(B) are engaged, respectively the autonomous humanoid robot 100 is shown cradled, respectively the charging module 1505(B) of the smart docking station is engaged with the autonomous humanoid robot charging module 1505(A) as exampled by black arrow; respectively thereafter, the computing system 1000 a computer readable medium is encoded with instructions which when executed by the charging process 1507 is detecting whether charging of the autonomous humanoid robot 100 is complete; wherein the computer readable medium is encoded with instructions to perform the steps for: disconnecting the charging process 1507 of the charging module 1505(B) in response to computer readable medium detecting, via sensor 121, the charging of the autonomous humanoid robot being complete.

In various applications the portable smart docking station utilizes the computing system 1000/1506 for controlling a charging procedure when the autonomous humanoid robot is docked and to control the transport process involving moving from one location to another location; other processes involve; the 1506 is configured for detecting whether charging of the autonomous humanoid robot is complete; and configured for disconnecting the charging process in response to the charging of the autonomous humanoid robot being complete; an array of sensor cameras configured to capture live images of the autonomous humanoid robot; the at least one camera performs processing for predicting image data based on the teaching image model of a computing system 1000, thus the current image of the situation is captured by the sensor camera during the aforementioned adjustment operation is constructed as a teaching image for mechanical learning; the computing system 1000 providing a motion control unit 1506a associated with a command value 1506b for operating movable body portion of the autonomous humanoid robot based on the command value 1506b; wherein the motion control unit calculates the command value 1506b based on the motion model, the current image, and the image, and the motion model learns the motion of the autonomous humanoid robot by a correlation with an image captured by the at least one of the sensor cameras; the command value 1506b based on an adjustment operation to adjust at least one of a position and a direction of a docking procedure of the autonomous humanoid robot 100.

As shown FIG. 15A illustrates a side view of the portable smart docking station comprising a framed hanger, hanger section configured with powered torsion hinges 1507a, 1507b for adjusting the cradling pressure against the autonomous humanoid robot 100 during a charging process 1507, when cradled, the powered charging terminal is engaged between the charging terminal 1505 and the autonomous humanoid robot charging module 1505(A); or is utilized to secure the autonomous humanoid robot therein when the autonomous humanoid robot requires transport from one location to another location.

In greater detail FIG. 15B illustrates a see through front view of the portable smart docking station 1500 detailing the outlined battery charging control system 1506, the battery charging control system 1506 providing a hanger opening function and a close hanger function, as shown the contoured hanger section 1502 is swung open and outwardly by mean of the powered torsion hinges 1507 activated by the open function, and the battery charging control system 1506 configured to receive signals from an array of sensors 119 and cameras (imaging device) 120/121 in which acquires an image captured by the imaging device, that is, a current image of the autonomous humanoid robot 100.

In some implementations, the contoured frame 1502 charging module 1505(B), a computing system 1000/1506 and a charging process 1507.

Wherein the contoured framed hanger 1502 is controlled mechanically for cradling the autonomous humanoid robot 100 via powered torsion hinges 1507 connecting to the AC cord 1508.

In some implementations, the base 1503 ii configured with a braking means when the autonomous humanoid robot is transporting or locking means 1505a, b-1505c, d.

Respectively the battery charging control system 1506 of the autonomous humanoid robot 100 is configured for handling operations and/or driving operations in operating environments 1050 such as disconnecting the charging process 1507 of the charging module 1505(B) in response to computer readable medium 1506(CRM) detecting, via sensor 119, the charging of the autonomous humanoid robot being complete. In various aspects the battery charging control system 1506 associated with a command value 1506b for operating movable body portion of the autonomous humanoid robot 100 based on the command value 1506b, wherein the battery charging control system 1506 calculates the command value 1506b based on an operating mode function 1050 function 1050s of the current image gathered from the sensors 119 and cameras 120, 121.

In various aspects the battery charging control system 1506 associated with a command value 1506b for operating movable body portion of the autonomous humanoid robot based on the command value 1506b, wherein the battery charging control system 1506 calculates the command value 1506b based on a battery power storage level.

In various aspects the control system 1501 associated with a command value 1506b for operating movable body portion of the autonomous humanoid robot based on the command value 1506b, wherein the control system 1501 calculates the command value 1506b based on the motion model, the current image, and the image, and the motion model learns the motion of the autonomous humanoid robot 100 by a correlation with an image captured by the at least one of the plurality of camera 121 and sensors 119, wherein the command value 1506b based on an adjustment operation to adjust at least one of a position and a direction of a docking procedure via the computing system 1000 of the autonomous humanoid robot 100.

In various aspects the computing system 1000 associated with In various aspects the battery charging control system 1506 associated with a command value 1506b for operating movable body portion of the autonomous humanoid robot 100 based on the command value 1506b, wherein the battery charging control system 1506 calculates the command value 1506b based on the motion model based on real time images attained by the cameras 120, 121 operational to the autonomous humanoid robot's computing system 1000 based on the sensors 119 and cameras 120, 121 configured to perceive motions or surroundings of the autonomous humanoid robot 100.

In various aspects when the autonomous humanoid robot 100 is to approach the cradle section and adjust a position in order to be cradled, such that the autonomous humanoid robot's charging module 1505(A) aligns with charging module 1505(B) of the smart docking station, when a electronically engaged, the autonomous humanoid robot charging module 1505(A) as exampled by arrow receives a charging process for a duration of time respectively thereafter, the control system 1501, based on encoded instructions, detects when the charging process is complete. Respectively, the control system 1501 initiates encoded instructions to perform the steps for disconnecting an electrical connection of the charging module 1505(B). Afterwards, the autonomous humanoid robot 100 can sleep for a period of time until user instruction 1101(I)s wakes-up the autonomous humanoid robot 100 (e. g., turns-on).

In greater detail FIG. 16 illustrates an operating environment 1600 such as a work space 1600(WS) 1600(WS) calibrated by a map 1601 generated by sensors like LIDAR, RADAR, ultrasonic sensors and by cameras 120/121. In some embodiments, an environment 1600, including but not limited to doorways, sub areas, perimeter openings, and information such as coverage pattern, room tags, order of rooms, etc. is available to the user through a graphical user interface (GUI) of the application of a communication device, such as a smartphone, computer, tablet, dedicated remote control, or any device that may display output data from the autonomous humanoid robot 100 and receive inputs from a user. Through the GUI, a user may review, accept, decline, or amend, for example, the map of the environment and settings, functions and operations of the autonomous humanoid robot 100 within the environment 1600, which may include, but are not limited to, type of coverage algorithm of the entire area or each subarea, correcting or adjusting map boundaries and the location of doorways, creating or adjusting subareas.

For example, a humanoid robot 100 including a cameras 120, 121 with a field of view land a field of view of cameras 120, 121 positioned within the environment. The position of the humanoid robot 100 relative of the cameras 120, 121 is variable. The data captured within the field of view of the cameras 120, 121 and the field of view of the CCTV cameras 120, 121 may be stitched together.

In some embodiments, it may be desirable for the processor a charge-coupled device (CCD) or complementary metal oxide semiconductor (CMOS) camera 120, 121 positioned at an angle relative to a horizontal plane combined with at least one IR point or line generator or any other structured form of light may also be used to perceive depths to obstacles within the environment 1050. Objects 116 may include, but are not limited to, articles, items, walls, boundary setting objects 116 or lines, furniture, obstacles, etc. that are included in the map. A boundary of a working environment may be considered to be within the working environment. In some embodiments, a camera 120, 121 is moved within an environment while depths from the camera 120, 121 to objects 116 are continuously (or periodically or intermittently) perceived within consecutively overlapping fields of view. Overlapping depths from separate fields of view may be combined to construct a map of the environment 1050.

In some embodiments, different types of data captured by different sensor 119 types combined into a single device may be stitched together. For instance, a single device including a cameras 120, 121 and a laser. Data captured by the cameras 120, 121 and data captured by the laser may be stitched together. At a first time point the cameras 120, 121 may only collect data. At a second time point, both the cameras 120, 121 and the laser may collect data to obtain depth and two dimensional image data. In some cases, different types of data captured by different sensor 119 types that are separate devices may be stitched together. For example, a 3D LIDAR and a cameras 120, 121 or a depth cameras 120, 121 and a cameras 120, 121, the data of which may be combined. For instance, a depth measurement may be associated with a pixel of an image captured by a cameras 120, 121. In some embodiments, data with different resolutions may be combined by, for example, regenerating and filling in the blanks or by reducing the resolution and homogenizing the combined data. For instance, in one example data with high resolution is combined. In some embodiments, the resolution in one directional perspective may be different than the resolution in another directional perspective. For instance, data collected by a sensor 119 of the humanoid robot 100 at a first time point and data collected at a second time point after the humanoid robot 100 rotates by a small angle are combines and may have a higher resolution from a vertical perspective.

As shown in FIG. 16 also illustrates a perception system 1607 for identifying images of a work space 1600(WS) obtaining, by a processor of the autonomous humanoid robot 100, the captured images; capturing, by a wheel encoder of the autonomous humanoid robot 100, movement data indicative of movement of the autonomous humanoid robot 100, capturing, by a LIDAR disposed on the autonomous humanoid robot 100, LIDAR data as the autonomous humanoid robot 100 performs work within the work space 1600(WS). Wherein the LIDAR data is indicative of distances from the LIDAR to object 116 and perimeters immediately surrounding the autonomous humanoid robot 100, comparing, by the processor of the autonomous humanoid robot 100, at least one object 116 from the captured images to object 116 in an object 116 dictionary, identifying, by the processor of the autonomous humanoid robot 100, a class to which the at least one object 116 belongs; and executing, by the autonomous humanoid robot 100, a mobility function and a navigation function, wherein the cleaning function comprises actuating a motor to control at least one of a motion and/or a position of the autonomous humanoid robot 100; generating, in a first operational session and after finishing an undocking routine, by the processor of the autonomous humanoid robot 100, a first iteration of a map of the work space 1600(WS) based on the LIDAR data, wherein the first iteration of the map is a bird-eye's view of at least a portion of the work space 1600(WS); generating, by the processor of the autonomous humanoid robot 100, additional iterations of the map based on newly captured LIDAR data and newly captured movement data obtained as the autonomous humanoid robot 100 performs coverage and traverses into new and undiscovered areas.

In some embodiments, newly captured LIDAR data comprises data corresponding with perimeters and object 116 that overlap with previously captured LIDAR data and data corresponding with perimeters that were not visible from a previous position of the autonomous humanoid robot 100 from which the previously captured LIDAR data was obtained; and the newly captured LIDAR data is integrated into a previous iteration of the map to generate a larger map of the work space 1600(WS), wherein areas of overlap are discounted them from the larger map; identifying, by the processor of the autonomous humanoid robot 100, a room in the map based on at least a portion of any of the captured images, the LIDAR data, and the movement data; actuating, by the processor of the autonomous humanoid robot 100, the autonomous humanoid robot 100 to drive along a trajectory that follows along a planned path by providing pulses to one or more electric motors of wheels of the autonomous humanoid robot 100; and localizing, by the processor of the autonomous humanoid robot 100, the autonomous humanoid robot 100 within an iteration of the map by estimating a position of the autonomous humanoid robot 100 based on the movement data, slippage, and sensor errors.

In some embodiments, the autonomous humanoid robot 100 performs coverage and finds new and undiscovered areas until determining, by the processor, all areas of the work space 1600(WS) are discovered and included in the map based on at least all the newly captured LIDAR data overlapping with the previously captured LIDAR data and the closure of all gaps the map; the map is transmitted to an application of a communication device previously paired with the autonomous humanoid robot 100; and the application is configured to display the map on a screen of the communication device.

In some embodiments, the object 116 flow of data in Linux based SLAM, indicated by path 1200. Respectively, SLAM 1200, data flows between real time sensors 119 and real time cameras 120 and 121. Wherein a Microcontroller Unit (MCU), the MCU and then between the MCU and CPU which may be slower due to several levels of abstraction in each step (MCU, OS, CPU). These levels of abstractions are noticeably reduced in Light Weight Real Time SLAM Navigational Stack, wherein data flows between real time sensors 1 and 2 and the MCU. While, Light Weight Real Time SLAM Navigational Stack may be more efficient, both types of SLAM may be used with the methods and techniques described herein.

User inputs are sent from the GUI to the autonomous humanoid robot 100 for implementation. For example, the user may use the application to create boundary zones or virtual barriers and cleaning areas. Accordingly, a user using an application of a communication device to create a map 1601 (or a yard area, for example) by touching the screen and dragging a corner of the rectangle in a particular direction to change the size of the map 1601. In this example, the rectangle is being expanded in direction 1602. An example of the user using the application to remove the map 1601 by touching and holding an area 1603 within map 1601 until a dialog box 1604 pops up and asks the user if they would like to remove the map 1601. An example of the user using the application to move boundary 1600 by touching an area 1605 within the map 1601 with two fingers and dragging the map 1601 to a desired location. In this example, map 1601 is moved in direction 1606. For example of the user using the application to rotate the map 1601 by touching an area 1606 within the map 1601 with two fingers and moving one finger around the other. In this example, map 1601 is rotated in direction 1607. An example of the user using the application to scale the map 1601 by touching an area 1608 within the map 1601 with two fingers and moving the two fingers towards or away from one another. In this example, map 1601 is reduced in size by moving two fingers towards each other in direction 1609 and expanded by moving two fingers away from one another in direction 1610. For example, a user changing the shape of map 1601 by placing their finger on a control point 1611 and dragging it in direction 1612 to change the shape.

The user adding a control point 1613 to the map 1601 by placing and holding their finger at the location at which the control point 1613 is desired. The user may move control point 1613 to change the shape of the map 1601 by dragging control point 1613, such as in direction 1614. For example, the user removing the control point 1613 from the map 1601 by placing and holding their finger on the control point 1613 and dragging it to the nearest control point 1615. This also changes the shape of map 1601. For example, to make a triangle from a rectangle, two control points may be merged. In some embodiments, the user may use the application to also define a task 1060 associated with each zone 1616(e.g., area).

For example of different zones created within a map 1601 using an application of a communication device. Different zones 1616 may be associated with different zones 1616 in particular are zones within which a mobile action 1617 is to be executed by the autonomous humanoid robot 100.

In some embodiments, the application may display the map of the environment as it is being built and updated. The application may also be used to define a path of the autonomous humanoid robot 100 and zones and label areas. For example, the user uses the application to define a path of the autonomous humanoid robot 100 using path tool to draw path. In some cases, the processor 1001 of the autonomous humanoid robot 100 may adjust the path defined by the user 1101 based on observations of the environment or the use may adjust the path defined by the processor; the user uses the application to define zones (e.g., service zones, work areas, etc.) using boundary tools; the user uses labelling tool to add labels such as bedroom, laundry, living room, and kitchen to the map. The kitchen may be shown with a particular hatching pattern to represent a particular task in that area. In some cases, the application displays the camera view of the autonomous humanoid robot 100. This may be useful for patrolling and searching for an item or object 116.

For example, the camera 120/121 view of the autonomous humanoid robot 100 is shown and a notification to the user 1101 that a cell phone has been found in the master bedroom. In some embodiments, the user 1101 may use the application to manually control the autonomous humanoid robot 100.

For example, for moving the autonomous humanoid robot 100 forward, for moving the autonomous humanoid robot 100 backwards, for rotating the autonomous humanoid robot 100 clockwise, for rotating the autonomous humanoid robot 100 counterclockwise, for toggling autonomous humanoid robot 100 between autonomous and manual mode (when in autonomous play symbol turns into pause symbol), for summoning the autonomous humanoid robot 100 to the user based on, for example, GPS location of the user's tablet, iPad, or iPhone, and for instructing the autonomous humanoid robot 100 to go to a particular area of the environment 1600. The particular area may be chosen from a dropdown list of different areas of the environment 1600, as displayed.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

I claim:

1. An autonomous humanoid robot comprising:
an autonomous humanoid robot configured to overcome limited maneuvering issues by offering a more efficient autonomous humanoid robot that autonomously operates to interact with users and interact with other robots, and includes a computing system configured to provide instruction and programming for estimating and controlling pivotal movement of body components involving arms, legs and a waist module which are configured to support the body and reposition the body such that the autonomous humanoid robot can step, walk, roll or skate or perform various handling maneuvers to complete a task;
based on user instruction, an algorithm configured for generating a first, second and third set of joint angular velocities, causes the autonomous humanoid robot to accomplish an operating mode function; to step, to walk, to roll, to skate, or to perform a series thereof to complete a task;
wherein the body is rotatably coupled to a head configuration, to arms, legs, the body's upper portion and bottom portion is configured with a waist module, a charge module, and batteries for powering the autonomous robot to move with human-like attitude;
each arm includes a respective shoulder joint, an elbow joint, a wrist joint coupled to an implement adapted for manipulating an object;
each leg includes a respective pivotal hip joint, a pivotal knee, an ankle joint coupled to a wheeled foot having a motor adapted to step, walk, roll or skate; wherein the wheeled foot's motor, when immobile (powered OFF), causes the wheeled foot to propel upwards to step, or the wheeled foot's motor, when mobile (powered ON), causes the wheeled foot's motor to propel at a slow speed to roll forward or backward, or the wheeled foot's motor propels at a fast speed to skate;
the waist module includes a respective servo configured to provide yaw, roll, and pitch motion, the servo adapted for bending at various angles to maintain balance at center mass (CM);
a plurality of perception system sensors and cameras configured for detecting an object surrounding the autonomous humanoid robot, the sensors and cameras providing object data and image data to a computing system;
the computing system comprising a plurality of processors, memory, programming, instructions and an application associated with operating mode functions in which the autonomous humanoid robot achieves various motion states to work;
a processor to activate a charging module situated on the body, based on a battery storage level, the charging module configured to charge one or more batteries;
a computing system, to engage and regulate velocity of the respective joints, waist servo and motor of the body to accomplish a motion state;
a balance control algorithm, and a momentum planning algorithm configured for estimating joint angular velocities of all joints of the autonomous humanoid robot according to a pose return-to-zero algorithm, such that the body maintains an upright position;
instructions for accomplishing pose control on the autonomous humanoid robot according to a first set of joint angular velocities, the second set of joint angular velocities, and the third set of joint angular velocities such that the body repositions to stand still or move with a pose attitude;
a momentum planning algorithm configured for controlling a turning motion of a hip joint of the leg such that the leg turns the wheeled foot at an angle, each leg and wheeled foot to steer the autonomous humanoid robot at a predetermined steering direction, respectively;
instructions for accomplishing a pose controlled position of the autonomous humanoid robot according to a first set of joint angular velocities, a second set of joint angular velocities, and a third set of joint angular velocities such that the autonomous humanoid robot can step, walk, roll, skate, or perform various acrobatic maneuvers;
a balance control algorithm configured for estimating joint angular velocities for bending to counter balance the body at CM;
a momentum planning algorithm configured for estimating joint angular velocities of all joints in order to adjust various maneuvers of the body such that the autonomous humanoid robot moves human like;
a computer-implemented control method configured for collecting posture information of posture sensors disposed on the body, and configured for estimating motion and position of the autonomous humanoid robot, such that the autonomous humanoid robot can perform one or more of the following human-like functions; a sports activity, a series of dance movements, or perform a vehicle-like mobility service, a mule or a towing-vehicle configured for transporting a payload or an object.

2. The autonomous humanoid robot according to claim 1, wherein the arm rotatably coupled a shoulder independently pivoting the arm with at least two degrees of freedom relative to the main body to accomplish reaching movement of the arm; wherein the shoulder joint and the pivotal elbow joint are simultaneously yet independently drivable by the motor to create forward and reverse motions relative to counter-balancing bending motions of the body such that the autonomous humanoid robot maintains balance.

3. The autonomous humanoid robot according to claim 1, wherein the hip joint of the leg rotatably coupled to a hip portion of the body, the hip joint for pivoting the leg with at least two degrees of freedom relative to the main body to accomplish swiveling movement of the leg; and wherein the joints about which the leg may move relative to the main body with at least two degrees of freedom of movement; and wherein the hip joint and the pivotal knee joint are simultaneously yet independently drivable by the motor to create forward stepping motion, reverse stepping motion, walking motion, jumping motions, or other human-like maneuvers.

4. The autonomous humanoid robot according to claim 1, wherein the drive assembly further comprises joint actuators and joint sensors for imparting driving pivotal movement to the hip joint, pivotal movement the knee joint, and rolling motion to the wheeled foot, respectively to move at various steering directions.

5. The autonomous humanoid robot according to claim 1, wherein the momentum planning algorithm configured for controlling a turning motion of a hip joint of the leg such that the leg turns the wheeled foot at an angle, each leg and wheeled foot to steer the autonomous humanoid robot at a predetermined steering direction, respective of user instruction.

6. The autonomous humanoid robot according to claim 1, wherein the waist module further securable relative to the main body, the waist module having a joint assembly adapted to pivot with at least two degrees of freedom relative to bending or twisting at a center portion of the body.

7. The autonomous humanoid robot according to claim 1, further comprising a swivel assembly secured to a hip portion of the body, the swivel assembly adapted to cooperate with the swivel shafts to pivot the leg with at least two degrees of freedom relative to the body.

8. The autonomous humanoid robot according to claim 1, wherein the plurality of perception system sensors and cameras configured for detecting objects surrounding the autonomous humanoid robot, the sensors and cameras providing object data and image data to a computing system comprising a plurality of processors.

9. The autonomous humanoid robot according to claim 1, wherein processors are configured for activating a charging module to charge one or more batteries so that power is controlled to regulate velocity of the joints of the body and the motor of the wheeled foot.

10. The autonomous humanoid robot according to claim 1, wherein the computing system comprising:
a computer-implemented control method configured for collecting posture information of posture sensors disposed on the body for estimating a first set of joint angular velocities of all joints of the autonomous humanoid robot according to a balance control algorithm;
instructions, based on user input, for estimating a second set of joint angular velocities of all joints of the autonomous humanoid robot according to a momentum planning algorithm; instructions for estimating a third set of joint angular velocities of all joints of the autonomous humanoid robot according to a pose return-to-zero algorithm; and
instructions for accomplishing pose control on the autonomous humanoid robot according to the first set of joint angular velocities, the second set of joint angular velocities, and the third set of joint angular velocities;
calibrates and controls motion and velocity of legs to achieve traverse repositioning of the wheeled foot, such that the wheeled foot steers the autonomous humanoid robot through a predetermined path, when, the wheeled foot's motor is powered the autonomous humanoid robot can achieve rolling motion to skate on pathways; and
controls motion and velocity of the wheeled foot's motor, when static, the wheeled foot is configured to achieve stepping motion or walking motion which is achieved by a computer-implemented dynamic footprint set generation method obtaining preset footprint calculation parameters, such that the autonomous humanoid robot can achieve stepping motion or walking motion to navigate up and down stairs or maneuver through obstructions;
the computing system, based on an application, establishes a switching sequence to initiate an operating mode function involving; a step mode, a walking mode, a skating mode, a leaping mode, a jumping mode, a battery charging mode, accordingly by combinations thereof, the autonomous humanoid robot can perform various physical motion states involving at least one of the following acts; a sports activity; a series of dance movements, perform a vehicle-like mobility service, or when operating as a mule or a towing-vehicle configured for transporting a payload or an object;
wherein the computer-implemented control method comprising: collecting posture information of posture sensors disposed on the body for estimating a first set of joint angular velocities of all joints of the autonomous humanoid robot according to a balance control algorithm; instructions for estimating a second set of joint angular velocities of all joints of the autonomous humanoid robot according to a momentum planning algorithm;
instructions for estimating a third set of joint angular velocities of all joints of the autonomous humanoid robot according to a pose return-to-zero algorithm; and instructions for accomplishing pose control on the autonomous humanoid robot according to the first set of joint angular velocities, the second set of joint angular velocities, and the third set of joint angular velocities such that the autonomous humanoid robot can step, walk, roll, skate, or perform acrobatic maneuvers to complete various tasks.

11. An autonomous humanoid robot comprising:
an autonomous humanoid robot configured to interact with users or to interact with other robots, and includes a computing system configured to provide instruction and programming for estimating and controlling pivotal movement of body components;
a plurality of arms and legs, a waist module, each configured to support the body, to reposition the body such that the autonomous humanoid robot steps, walks, rolls or skates to a destination or maneuvers to complete task;
a wheeled foot comprising a motor, the motor, when immobile (powered OFF), causes the wheeled foot to propel upwards to step, or the motor, when mobile (powered ON), causes the wheeled foot's motor to propel at a slow speed to roll forward or backward, or the wheeled foot's motor propels at a fast speed to skate;
the waist module operatively associated with a joint providing yaw, roll, and pitch motion for counter balancing the body at center mass;
a plurality of perception system sensors and cameras configured for detecting object surrounding the autonomous humanoid robot, the sensors and cameras providing object data and image data to a computing system comprising a plurality of processors;
based on a battery storage level, a processor to activates a charging module to charge one or more batteries so that power is controlled, by the computing system, to engage and regulate velocity of the joints and motors of the body;
a computer-implemented control method configured for collecting posture information of posture sensors disposed on the body for estimating motion and position of the autonomous humanoid robot such that the autonomous humanoid robot completes a task to maneuver according to user instructions;
a balance control algorithm, and a momentum planning algorithm configured for estimating joint angular velocities of all joints of the autonomous humanoid robot according to a pose return-to-zero algorithm, such that the body maintains an upright position;
based on motion control algorithms, instructions for accomplishing pose control on the autonomous humanoid robot according to a first set of joint angular velocities, the second set of joint angular velocities, and the third set of joint angular velocities such that the body repositions to stand still or move with a pose attitude;
a momentum planning algorithm configured for controlling a turning motion of a hip joint of the leg such that the leg turns the wheeled foot at an angle, each leg and wheeled foot to steer the autonomous humanoid robot at a predetermined steering direction, respective of user instruction.

12. The autonomous humanoid robot according to claim 11, wherein the arm rotatably coupled a shoulder independently pivoting the arm with at least two degrees of freedom relative to the main body to accomplish reaching movement of the arm; wherein the shoulder joint and the pivotal elbow joint are simultaneously yet independently drivable by the motor to create forward and reverse motions relative to counter-balancing bending motions of the body.

13. The autonomous humanoid robot according to claim 11, wherein the hip joint of the leg rotatably coupled to a hip portion of the body, the hip joint for pivoting the leg with at least two degrees of freedom relative to the main body to accomplish swiveling movement of the leg; and wherein the joints about which the leg may move relative to the main body with at least two degrees of freedom of movement; and wherein the hip joint and the pivotal knee joint are simultaneously yet independently drivable by the motor to create forward and reverse stepping motions, or walking motions, or jumping motions.

14. The autonomous humanoid robot according to claim 11, wherein the drive assembly further comprises a joints and joint sensors for imparting driving pivotal movement to the hip joint, pivotal movement to the knee joint, and rolling motion to the wheeled foot, to achieve traverse repositioning of the wheeled foot, such that the wheeled foot steers the autonomous humanoid robot, respectively.

15. The autonomous humanoid robot according to claim 11, further comprising a drive for the motor to drive the pivoting movement of the knee joint and the rolling motion of the wheeled foot.

16. The autonomous humanoid robot according to claim 11, wherein the waist module further securable relative to the main body, the waist module having a joint assembly adapted to pivot with at least two degrees of freedom relative to bending or twisting at a center portion of the body.

17. The autonomous humanoid robot according to claim 11, further comprising a swivel assembly secured to a hip portion of the body, the swivel assembly adapted to cooperate with the swivel shafts to pivot the leg with at least two degrees of freedom relative to the body.

18. The autonomous humanoid robot according to claim 11, wherein the plurality of perception system sensors and cameras configured for detecting objects surrounding the autonomous humanoid robot, the sensors and cameras providing object data and image data to a computing system comprising a plurality of processors.

19. The autonomous humanoid robot according to claim 11, wherein processors are configured for activating a charging module to charge one or more batteries so that power is controlled to regulate velocity of the joints and motors of the body.

20. The autonomous humanoid robot according to claim 11, wherein the computing system comprising: computer-implemented control method comprising:
computer-implemented control method configured for collecting posture information of posture sensors disposed on the body for estimating a first set of joint angular velocities of all joints of the autonomous humanoid robot according to a balance control algorithm; instructions for estimating a second set of joint angular velocities of all joints of the autonomous humanoid robot according to a momentum planning algorithm; instructions for estimating a third set of joint angular velocities of all joints of the autonomous humanoid robot according to a pose return-to-zero algorithm; and
instructions for accomplishing pose control on the autonomous humanoid robot according to the first set of joint angular velocities, the second set of joint angular velocities, and the third set of joint angular velocities;
calibrates and controls motion and velocity of leg's hip joints adjust at various angles to achieve traverse repositioning of the wheeled foot, such that the wheeled foot turns to steers the autonomous humanoid robot through a predetermined path, when, the wheeled foot's motor is powered the autonomous humanoid robot can achieve rolling motion to skate on pathways; and
controls motion and velocity of the wheeled foot's motor, when static, the wheeled foot is configured to achieve stepping motion or walking motion which is achieved by a computer-implemented dynamic footprint set generation method obtaining preset footprint calculation parameters, such that the autonomous humanoid robot autonomously achieves a stepping motion, or a walking motion to navigate up or down stairs, or maneuvers through an obstruction;
the computing system, based on an application establishes a switching sequence to initiate an operating mode function involving one or more of the following; a step mode, a walking mode, a skating mode, a leaping mode, a jumping mode, a battery charging mode, a fall recovery, the autonomous humanoid robot configured for accomplishing various physical motion states involving one or more of the following; a sports activity, a series of dance movements, perform a vehicle-like mobility service, or when operating as a mule or a towing-vehicle, accordingly the autonomous humanoid robot can transport a payload or an object.
